(19) United States
(12) Patent Application Publication
(10) Pub. No.: US 2026/0060239 A1
(43) Pub. Date: Mar. 5, 2026

(54) NATURAL-BASED SALICYLIC ACID POLY(ANHYDRIDE ESTER) HYDROGELS FOR AGRICULTURAL APPLICATIONS

(71) Applicant: The Regents of The University of California, Oakland, CA (US)

(72) Inventors: Kathryn Uhrich, Riverside, CA (US); Mariana Reis Nogueira de Lima, Riverside, CA (US)

(21) Appl. No.: 19/104,187

(22) PCT Filed: Aug. 23, 2023
(86) PCT No.: PCT/US2023/072773

§ 371 Date: Feb. 14, 2025

Related U.S. Application Data
(60) Provisional application No. 63/400,391, filed on Aug. 23, 2022.
(60) Provisional application No. 63/400,730, filed on Aug. 24, 2022.
(60) Provisional application No. 63/519,209, filed on Aug. 11, 2023.

(51) Int. Cl. A01N 25/10; A01P 21/00; C08G 63/60

(52) U.S. Cl. CPC A01N 25/10; C08G 63/60; A01P 21/00

(57) ABSTRACT

The present invention provides novel bioactive and biocompatible polymers derived from salicylic acid and itaconic acid. The present invention also provides hydrogels formed from these bioactive and biocompatible polymers, and methods of using such hydrogels to promote plant growth and/or to increase drought and stress tolerance.

### CROSS-REFERENCES TO RELATED APPLICATIONS

This application is related to U.S. Provisional Patent Application Ser. No. 63/400,391, filed on Aug. 23, 2022; U.S. Provisional Patent Application Ser. No. 63/400,730, filed on Aug. 24, 2022; U.S. Provisional Patent Application Ser. No. 63/519,209, filed on Aug. 11, 2023; all of which are incorporated by reference in their entirety for all purposes.

### STATEMENT AS TO RIGHTS TO INVENTIONS MADE UNDER FEDERALLY SPONSORED RESEARCH AND DEVELOPMENT

NOT APPLICABLE

### BACKGROUND OF THE INVENTION

Hydrogels are three-dimensional hydrophilic crosslinked polymer networks that can absorb large volumes of water without dissolving. Hydrogels may be comprised of both polymers that are insoluble due to the presence of physical crosslinks (e.g., crystalline regions, intermolecular interactions, and entanglements) or chemical crosslinks (e.g., covalent bonding) or soluble in water. Hydrogels are becoming increasingly important for a variety of agricultural applications, including combating drought stress, delivery of an agent to the plant, and aid in plant growth and production. To improve plant growth while combating drought stress, biologically active compounds can be chemically or physically incorporated into hydrogel networks. While plants have natural adaptive response to survive under stress conditions, their response is not enough to secure food production. Natural polymers have gained attention for use in combating drought stress due to their biocompatibility, biodegradability, and water solubility. Unfortunately, natural hydrogels can, at times, be unstable or provide less desired properties needed for a hydrogel in use in agriculture. To overcome such deficiencies, it would be great if synthetic polymers that are biocompatible could be used; however, at present, no synthetics hydrogel compositions exhibit positive effects to the plants upon degradation. Thus, there is a need in the art for a synthetic hydrogel that exhibits positive effects, such as being bioactive, to plants upon degradation.

### BRIEF SUMMARY OF THE INVENTION

The present invention provides biocompatible and biodegradable polymers, both homopolymers and copolymers, derived from salicylic acid and itaconic acid that can be used to generate hydrogels useful for combating drought stress and/or for controlling the release of fertilizers against drought stress. In some embodiments, the hydrogels disclosed herein can be advantageously used to promote or increase the growth of a seedling, a plant, or a crop and/or to increase the drought tolerance of a seedling, a plant, or a crop.

In one aspect, the present invention provides a homopolymer having a backbone, wherein the backbone comprises one or more units of Formula (I):

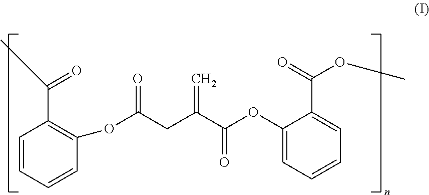

wherein n is 2 to 1500. In one embodiment, the homopolymer has an average molecular weight of about 1,000 daltons to about 700,000 daltons. In another aspect, the homopolymer has an average molecular weight of about 100,000 daltons to about 600,000 daltons. In yet another embodiment, the homopolymer has an average molecular weight of about 200.000 daltons to about 500,000 daltons. In one embodiment, hydrolysis of the homopolymer yields the following products:

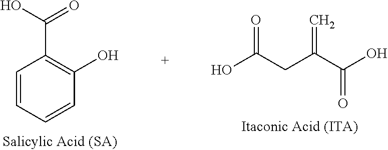

As will be appreciated by those of ordinary skill in the art, salicylic acid (SA), a defense plant hormone, is responsible for regulating many plant functions, such as seed germination, plant respiration, cell growth, and response to abiotic stresses, etc. Salicylic acid improves the photosynthesis, membrane permeability, and the activity of the antioxidant enzymes, all of which are negatively impacted by drought or stress conditions. Thus, salicylic acid can advantageously be used to promote. i.e., increase, the growth of a seedling, a plant, or a crop and/or to increase the drought tolerance of a seedling, a plant, or a crop. In another embodiment, the homopolymer of Formula (I) further comprises an active agent, such as, for example, a fertilizer, urea, monopotassium-phosphate, a pesticide, or any other agent that would be useful for increasing growth and/or drought or stress tolerance.

In another aspect, the present invention provides a copolymer having a backbone, wherein the backbone comprises: (a) one or more units of Formula (I):

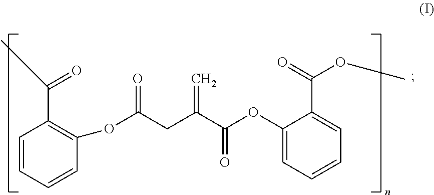

and
(b) one or more units of Formula (II):

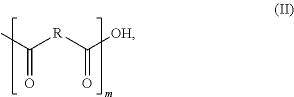

wherein: n is 1 to 1500; m is 1 to 1500; and each R is independently a linker. In some embodiments, n is 1 to 2000. In one embodiment, the linker R is a divalent, branched or unbranched, saturated or unsaturated, hydrocarbon chain, having from 1 to 25 carbon atoms, and wherein one or more of the carbon atoms is optionally replaced by (—O—), (—NR¹—) or phenylene, and wherein the chain is optionally substituted on one or more carbon with one or more substituents selected from the group consisting of (C₁-C₆)alkoxy, (C₁-C₆)cycloalkyl, (C₁-C₆)alkanoyl, (C₁-C₆)alkanoyloxy, (C₁-C₆)alkoxycarbonyl, (C₁-C₆)alkylthio, azido, cyano, nitro, halo, hydroxy, oxo, carboxy, aryl, aryloxy, heteroaryl, and heteroaryloxy, wherein each R¹ is independently selected from H or (C₁-C₆)alkyl. In one embodiment, the linker R includes, but is not limited to, the following:

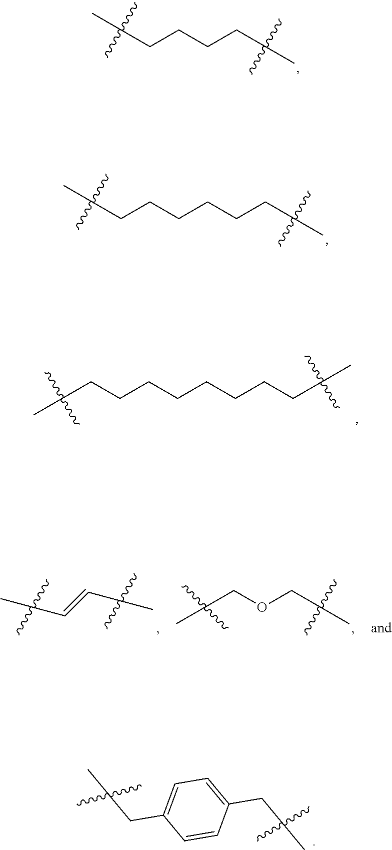

In one embodiment, the copolymer has an average molecular weight of about 1,000 daltons to about 700,000 daltons. In another aspect, the copolymer has an average molecular weight of about 100,000 daltons to about 600,000 daltons. In yet another embodiment, the copolymer has an average molecular weight of about 200,000 daltons to about 500,000 daltons.

In one embodiment, the ratio of the (a) one or more units of Formula (I) to the (b) one or more units of Formula (II) ranges from between 10:1 to 1:10. In another embodiment, the ratio of the (a) one or more units of Formula (I) to the (b) one or more units of Formula (II) ranges from between 5:1 to 1:5. In yet another embodiment, the ratio of the (a) one or more units of Formula (I) to the (b) one or more units of Formula (II) ranges from between 2:1 to 1:2. In still another embodiment, the ratio of the (a) one or more units of Formula (I) to the (b) one or more units of Formula (II) ranges from between 1:1 or 2:1.

In one embodiment, hydrolysis of the homopolymer yields the following products:

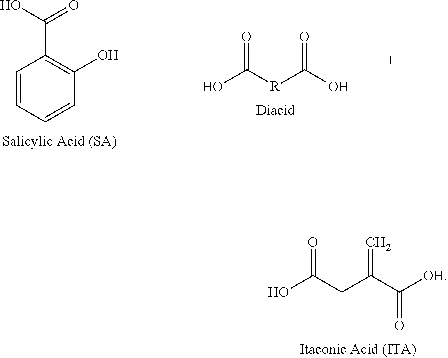

In another embodiment, the copolymer further comprises an active agent, such as a fertilizer, urea, monopotassium-phosphate, a pesticide, or any other agent (such as antimicrobial, anti-fungal, antioxidant, etc.) that would be useful for increasing growth and/or drought or stress tolerance. In some embodiments, the copolymer and active agent are synthetically combined such that the active agent is embedded, entangled, or contained within the polymer, such as in the backbone of the copolymer. In some embodiments, the active agent is added during the synthesis of the copolymer such that the active agent is entangled, embedded, or contained within the polymer structure.

In another aspect, the present invention provides a copolymer having a backbone, wherein the backbone comprises: (a) one or more units of Formula (III):

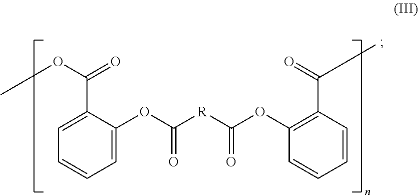

and
(b) one or more units of Formula (IV):

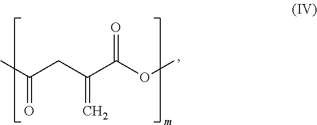

wherein n is 1 to 1500; m is 1 to 1500; and each R is independently a linker. In one embodiment, the linker R is a divalent, branched or unbranched, saturated or unsaturated, hydrocarbon chain, having from 1 to 25 carbon atoms, and wherein one or more of the carbon atoms is optionally replaced by (—O—), (—NR¹—) or phenylene, and wherein the chain is optionally substituted on carbon with one or more substituents selected from the group consisting of (C₁-C₆)alkoxy, (C₃-C₆)cycloalkyl, (C₁-C₆)alkanoyl, (C₁-C₆)alkanoyloxy, (C₁-C₆)alkoxycarbonyl, (C₁-C₆)alkylthio, azido, cyano, nitro, halo, hydroxy, oxo, carboxy, aryl, aryloxy, heteroaryl, and heteroaryloxy, wherein each R¹ is independently selected from H or (C₁-C₆)alkyl. In one embodiment, the linker R includes, but is not limited to, the following:

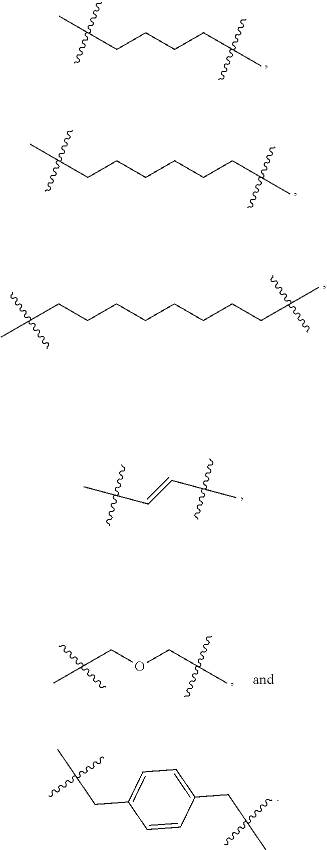

In one embodiment, the copolymer has an average molecular weight of about 1,000 daltons to about 700,000 daltons. In another aspect, the copolymer has an average molecular weight of about 100,000 daltons to about 600,000 daltons. In yet another embodiment, the copolymer has an average molecular weight of about 200,000 daltons to about 500,000 daltons.

In one embodiment, the ratio of the (a) one or more units of Formula (III) to the (b) one or more units of Formula (IV) ranges from between 10:1 to 1:10. In another embodiment, the ratio of the (a) one or more units of Formula (III) to the (b) one or more units of Formula (IV) ranges from between 5:1 to 1:5. In yet another embodiment, the ratio of the (a) one or more units of Formula (III) to the (b) one or more units of Formula (IV) ranges from between 2:1 to 1:2. In still another embodiment, the ratio of the (a) one or more units of Formula (III) to the (b) one or more units of Formula (IV) ranges from between 1:1 or 2:1.

In one embodiment, hydrolysis of the homopolymer yields the following products:

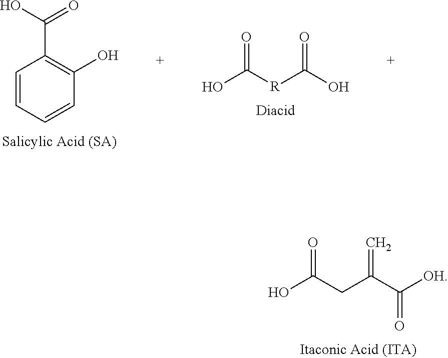

In another embodiment, the copolymer further comprises an active agent, such as a fertilizer, urea, monopotassium-phosphate, a pesticide, or any other agent (such as antimicrobial, anti-fungal, antioxidant, etc.) that would be useful for increasing growth and/or drought or stress tolerance. In some embodiments, the copolymer and active agent are synthetically combined such that the active agent is embedded, entangled, or contained within the polymer, such as in the backbone of the copolymer. In some embodiments, the active agent is added during the synthesis of the copolymer such that the active agent is entangled, embedded, or contained within the polymer structure. In some embodiments, the active agent may be attached to the backbone via crosslinking to form a pendant chain.

In another aspect, the present invention provides hydrogels formed from the homopolymers and/or copolymers disclosed herein, either on their own or, optionally, in combination with a second copolymer, wherein the second copolymer includes, but is not limited to, a synthetic copolymer, a natural copolymer, and combinations thereof.

In one embodiment, the present invention provides a hydrogel comprising a plurality of homopolymers having a backbone, wherein the backbone comprises one or more units of Formula (I):

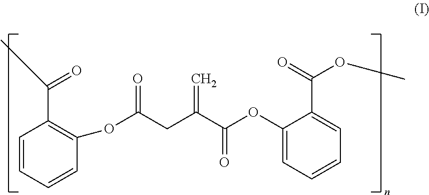

wherein n is 2 to 1500; and wherein the homopolymers are cross-linked.

In another embodiment, the present invention provides a hydrogel comprising a plurality of copolymers having a backbone, wherein the backbone comprises: (a) one or more units of Formula (I):

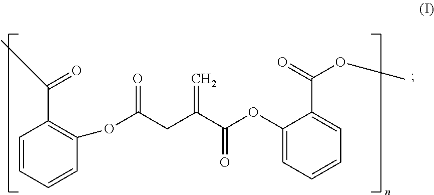

and
(b) one or more units of Formula (II):

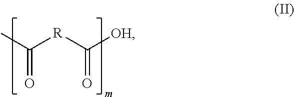

wherein: n is 1 to 1500; m is 1 to 1500; and each R is independently a linker; and wherein the copolymers are cross-linked.

In another embodiment, the present invention provides a hydrogel comprising a plurality of copolymers having a backbone, wherein the backbone comprises: (a) one or more units of Formula (III):

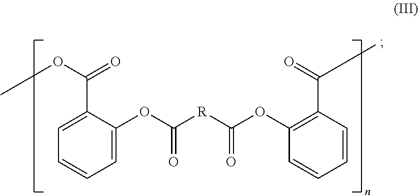

and
(b) one or more units of Formula (IV):

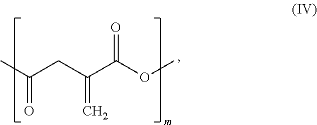

wherein: n is 1 to 1500; m is 1 to 1500; and each R is independently a linker; and wherein the copolymers are cross-linked

In another embodiment, the present invention provides a homopolymer for treating a plant, seed, or crop comprising one or more units of Formula (III):

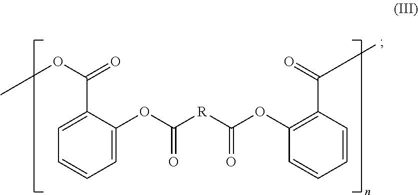

wherein: n is 1 to 1500; and each R is independently a linker. In one embodiment, the linker R is a divalent, branched or unbranched, saturated or unsaturated, hydrocarbon chain, having from 1 to 25 carbon atoms, and wherein one or more of the carbon atoms is optionally replaced by (—O—), (—NR¹—) or phenylene, and wherein the chain is optionally substituted on one or more carbon with one or more substituents selected from the group consisting of (C₁-C₆)alkoxy. (C₃-C₆)cycloalkyl, (C₁-C₆)alkanoyl, (C₁-C₆)alkanoyloxy. (C₁-C₆)alkoxycarbonyl, (C₁-C₆)alkylthio, azido, cyano, nitro, halo, hydroxy, oxo, carboxy, aryl, aryloxy, heteroaryl, and heteroaryloxy, wherein each R¹ is independently selected from H or (C₁-C₆)alkyl. In one embodiment, the linker R includes, but is not limited to, the following:

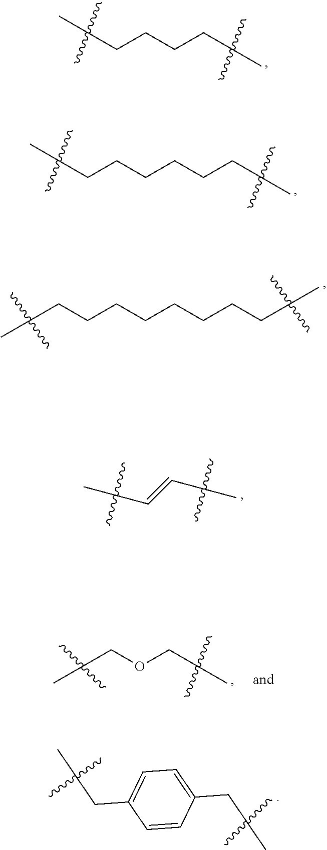

In yet another embodiment, the present invention provides a hydrogel comprising a homopolymer as disclosed herein and a second copolymer, wherein the second copolymer includes, but is not limited to, a synthetic polymer, a natural polymer, and combinations thereof, wherein the homopolymer and the second copolymer are cross-linked. In still another, the present invention provides a hydrogel comprising a copolymer as disclosed herein and a second copolymer, wherein the second copolymer includes, but is not limited to, a synthetic polymer, a natural polymer, and combinations thereof, wherein the copolymer and the second copolymer are cross-linked. In one embodiment, the copolymer used in forming the hydrogel with the second copolymer, such as a synthetic polymer or a natural polymer, has a backbone comprising (a) one or more units of Formula (I):

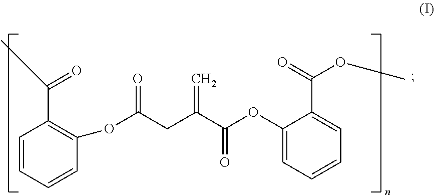

and
(b) one or more units of Formula (II):

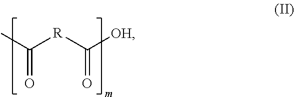

wherein: n is 1 to 1500; m is 1 to 1500; and each R is independently a linker as disclosed herein. In another embodiment, the copolymer used in forming the hydrogel with the second copolymer, such as a synthetic polymer or a natural polymer, has a backbone comprising (a) one or more units of Formula (III):
and

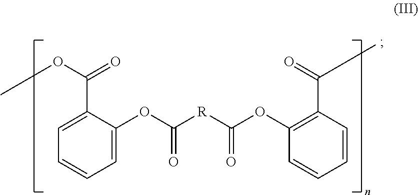

(b) one or more units of Formula (IV):

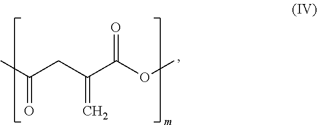

wherein: n is 1 to 1500; m is 1 to 1500; and each R is independently a linker as disclosed herein.

In another embodiment, the hydrogel is formed from the two copolymers disclosed herein. In this embodiment, the one copolymer has a backbone comprising (a) one or more units of Formula (I):

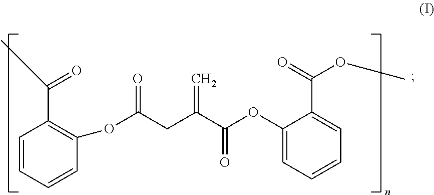

and
(b) one or more units of Formula (II):

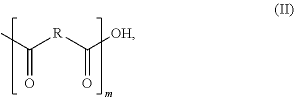

wherein: n is 1 to 1500; m is 1 to 1500; and each R is independently a linker as disclosed herein, and the second copolymer has a backbone comprising (a) one or more units of Formula (III):

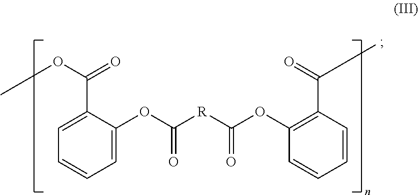

and
(b) one or more units of Formula (IV):

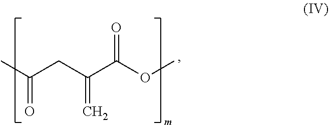

wherein: n is 1 to 1500; m is 1 to 1500; and each R is independently a linker as disclosed herein. In this embodiment, the two copolymers are crosslinked.

In another aspect, the present invention provides methods of using the hydrogels disclosed herein to increase or promote the growth of a seed, a seedling, a plant, or a crop and/or to increase drought or stress tolerance of a seed, a seedling, a plant, or a crop. In one embodiment, the present invention provides a method for delivering salicylic acid to a seed, a plant, or a crop, the method comprising applying to (or coating or contacting) the seed, the plant (or a portion thereof), or the crop a hydrogel disclosed herein. In another embodiment, the present invention provides a method for combating drought stress or increasing drought tolerance, the method comprising applying to (or coating or contacting) a seed, a plant, or a crop with a hydrogel disclosed herein. In yet another embodiment, the present invention provides a method for promoting plant growth and production, the method comprising applying to (or coating or contacting) a plant a hydrogel disclosed herein. In another embodiment, the present invention provides a method for increasing the growth of a seedling and/or increasing the drought tolerance of a seedling, the method comprising (a) coating a seed for the desired seedling with a hydrogel disclosed herein, (b) planting the coated seed in growth conditions, such as in soil, and (c) allowing the seed to grow into a seedling, thereby increasing the growth of the seedling and/or increasing the drought tolerance of the seedling.

### BRIEF DESCRIPTION OF THE DRAWINGS

FIG. 1 is a schematic of an exemplary homopolymer for generating hydrogels, according to one embodiment of the present disclosure.

FIG. 2A provides photographs of 5%, 10% or 20% (w/v) CMC with CaCl₂ crosslinking agent. FIG. 2B provides photographs of 5%, 10% or 20% (w/v) CMC with CaCl₂ crosslinking agent and incorporation of SAPAE homopolymer. FIG. 2C provides photographs of 5%, 10% or 20% (w/v) CMC with CaCl₂ crosslinking agent and the incorporation of salicylic acid.

FIG. 3 provides photographs of the surface topography of the hydrogel with no salicylic acid or SAPAE (FIG. 3A), with the incorporation of salicylic acid (FIG. 3B), or with the incorporation of SAPAE homopolymer (FIG. 3C).

FIG. 4A provides ATR-FTIR illustrations for the CMC, the CMC with CaCl₂, SAPAE, and the hydrogel after formation. FIG. 4B provides ATR-FTIR illustrations for the CMC, CMC with CaCl₂), salicylic acid, and of the hydrogel after formation.

FIG. 5A provides photographs of degree of swelling for 5%, 10% or 20% (w/v) CMC with CaCl₂ crosslinking agent at time points 0, 2, 4, 6, and 24 hours. FIG. 5B provides photographs of degree of swelling for 5%, 10% or 20% (w/v) CMC with CaCl₂ crosslinking agent at time points 0, 2, 4, 6, and 24 hours with the incorporation of SAPAE homopolymer. FIG. 5C provides photographs of degree of swelling for 5%, 10% or 20% (w/v) CMC with CaCl₂ crosslinking agent at time points 0, 2, 4, 6, and 24 hours with the incorporation of salicylic acid.

FIG. 6A provides a graph for the degree of swelling of a hydrogel formed from CMC and crosslinked with CaCl₂. FIG. 6B provides a graph of the degree of swelling of a hydrogel formed from CMC, SAPAE and crosslinking agent CaCl₂. FIG. 6C provides a graph of the degree of swelling of a hydrogel formed from CMC, crosslinking agent CaCl₂, and salicylic acid.

FIG. 7 provides a schematic of an exemplary dosage window schedule for the eight groups: DI-water, SAPAE 1x (single application of 0.15 mmol of SA incorporated in the polymer), SA 3x (three applications of 0.05 mmol of SA), SA 1x (single application of 0.15 mmol of SA), according to one embodiment of the present disclosure.

FIG. 8A provides representative images of images of micro-tom plants post dosage window (7 days) under DI-water, SA 1x, SA 3x and SAPAE 1x treatments, and death example (FIG. 8A) and FIG. 8B provides a graph of the average percent micro-tom survival post dosage window (7 days) under DI-water, SA 1x, SA 3x and SAPAE 1x treatments (72 plants per group).

FIG. 9A provides a graph of the percent of plant growth based on plant height. FIG. 9B provides a graph of the variation in the total number of branches per plant treated DI-water, SAPAE 1x, SA 1x and SA 3x during dosage window. FIG. 9C provides a graph of the variation in the total number of leaves per plant treated with DI-water, SAPAE 1x, SA 1x and SA 3x during dosage window.

FIG. 10A provides a graph of the percent of plant growth based in plant height after 14 days from dosage window. FIG. 10B provides a graph of the variation in the total number of branches per plant. FIG. 10C provides a graph of the variation in the total number of leaves per plant for plants treated with DI-water, SAPAE 1x, SA 1x and SA 3x in 14 days post dosage under normal and drought stress conditions.

FIG. 11A provides a graph of the average number of flower buds per plant after 14 days from dosage window. FIG. 11B provides a graph of the total number of opened flowers per group for plants treated with DI-water, SAPAE 1x, SA 1x and SA 3x in 14 days post dosage.

FIG. 12 provides a graph of the percent survival post dosage window where the plants were submitted to either drought stress or normal conditions.

FIG. 13A provides a graph of the percent plant growth based on plant height. FIG. 13B provides a graph of the variation in total number of branches per plant treated DI-water, SAPAE 1x, SA 1x and SA 3x during dosage window. FIG. 13C provides a graph of the variation in the total number of leaves per plant treated DI-water, SAPAE 1x, SA 1x and SA 3x during dosage window.

FIG. 14A provides a graph of the average number of flower buds per plant treated DI-water, SAPAE 1x. SA 1x and SA 3x during dosage window. FIG. 14B provides a graph of the average number of opened flowers per plant treated DI-water, SAPAE 1x. SA 1x and SA 3x during dosage window. FIG. 14C provides a graph of the average number of tomatoes per plant for plants treated DI-water, SAPAE 1x, SA 1x and SA 3x during dosage window.

FIG. 15 provides photographs of the individual tomato plants removed from the study at harvest day.

FIG. 16A provides a graph of the percent plant growth based in plant height for plants treated with DI-water, SAPAE 1x, SA 1x and SA 3x during dosage window. FIG. 16B provides a graph of the initial plant height (cm) for plants treated with DI-water, SAPAE 1x, SA 1x and SA 3x during dosage window. FIG. 16C provides a graph of the final plant height (cm) for plants treated with DI-water, SAPAE 1x, SA 1x and SA 3x during dosage window.

FIG. 17A provides a graph of the variation in the total number of branches per plant for plants treated with DI-water, SAPAE 1x, SA 1x and SA 3x during the entirety of the study (1^{st} dose until harvest). FIG. 17B provides a graph of the variation in the total number of leaves per plant for treated with DI-water, SAPAE 1x, SA 1x and SA 3x during the entirety of the study (1^{st} dose until harvest). FIG. 17C provides a graph of the average plant mass in grams for plants treated with DI-water, SAPAE 1x, SA 1x and SA 3x during the entirety of the study (1^{st} dose until harvest). FIG. 17D provides a graph of the root length for plants treated with DI-water, SAPAE 1x, SA 1x and SA 3x during the entirety of the study (1^{st} dose until harvest).

FIG. 18 provides photographs of the harvested tomatoes from each test group treated with DI-water, SAPAE 1x, SA 1x and SA 3x during the entirety of the study (1^{st} dose until harvest).

FIG. 19A provides a graph of the total number of tomatoes per group for plants treated with DI-water. SAPAE 1x, SA 1x and SA 3x at the harvest day. FIG. 19B provides a graph of the total number of red tomatoes per group for plants treated with DI-water, SAPAE 1x, SA 1x and SA 3x at the harvest day. FIG. 19C provides a graph of the average tomato height (mm) for plants for plants treated with DI-water, SAPAE 1x, SA 1x and SA 3x at the harvest day. FIG. 19D provides a graph of the average tomato diameter (mm) for plants treated with DI-water, SAPAE 1x, SA 1x and SA 3x at the harvest day.

### DEFINITIONS

Unless defined otherwise, all technical and scientific terms used herein have the same meaning as is commonly understood by one of skill in the art to which the claimed subject matter belongs. It is to be understood that the foregoing general description and the following detailed description are exemplary and explanatory only and are not restrictive of any subject matter claimed. The section headings used herein are for organizational purposes only and are not to be construed as limiting the subject matter described. In this application, the use of the singular includes the plural unless specifically stated otherwise. It is noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include,” “includes.” and “included,” is not limiting.

As used herein, ranges and amounts can be expressed as “about” a particular value or range. About also includes the exact amount, but also allows a reasonable amount of deviation of the modified term such that the end result is not significantly changed. The term about should be construed as including a deviation of at least 5% of the modified term if this deviation would not negate the meaning of the word it modifies. Generally, the term “about” includes an amount that would be expected to be within experimental error.

Specific values listed below for radicals, substituents, and ranges are for illustration only; they do not exclude other defined values or other values within defined ranges for the radicals and substituents.

As used herein, the terms “comprising” and “comprises” are intended to mean that the methods, compounds, compositions, and respective components thereof include the recited elements, but do not exclude others. “Consisting essentially of” refers to those elements required for a given embodiment. The phrase permits the presence of additional elements that do not materially affect the basic and novel or functional characteristic(s) of the given embodiment (e.g., methods, compounds, or compositions). “Consisting of” refers to methods, compounds, compositions, and respective components thereof, as described herein, which are exclusive of any element not recited in that description of the embodiment. Embodiments defined by each of these transition terms are within the scope of this disclosure.

As used herein, the term “alkyl,” by itself or as part of another substituent, refers to a straight or branched, saturated, aliphatic radical having the number of carbon atoms indicated. Alkyl can include any number of carbons, such as C₁₋₂, C₁₋₃, C₁₋₄, C₁₋₅, C₁₋₆, C₁₋₇, C₁₋₈, C₁₋₉, C₁₋₁₀, C₁₋₁₁, C₁₋₁₂, C₂₋₃, C₂₋₄, C₂₋₃, C₂₋₆, C₃₋₄, C₃₋₅, C₃₋₆, C₄₋₅, C₄₋₆ and C₅₋₆. For example, C₁₋₆ alkyl includes, but is not limited to, methyl, ethyl, propyl, isopropyl, butyl, isobutyl, sec-butyl, tert-butyl, pentyl, isopentyl, hexyl, etc. Alkyl can also refer to alkyl groups having up to 20 carbons atoms, such as, but not limited to heptyl, octyl, nonyl, decyl, etc. Unless otherwise specified, alkyl groups can be substituted or unsubstituted. For example, “substituted alkyl” groups can be an alkyl group substituted with one or more groups selected from halo, hydroxy, amino, aminoalkyl, amido, and alkoxy.

As used herein, the term “alkoxy,” by itself or as part of another substituent, refers to a group having the formula —OR, wherein R is alkyl as described above.

As used herein, the term “cycloalkyl,” by itself or as part of another substituent, refers to a saturated or partially unsaturated, monocyclic, fused bicyclic or bridged polycyclic ring assembly containing from 3 to 12 ring atoms, or the number of atoms indicated. Cycloalkyl can include any number of carbons, such as C₃₋₆, C₄₋₆, C₅₋₆, C₃₋₈, C₄₋₈, C₅₋₈, C₆₋₈, C₃₋₉, C₃₋₁₀, C₃₋₁₁, and C₃₋₁₂. Saturated monocyclic cycloalkyl rings include, for example, cyclopropyl, cyclobutyl, cyclopentyl, cyclohexyl, and cyclooctyl. Saturated bicyclic and polycyclic cycloalkyl rings include, for example, norborane, [2.2.2] bicyclooctane, decahydronaphthalene and adamantane. Cycloalkyl groups can also be partially unsaturated, having one or more double or triple bonds in the ring. Representative cycloalkyl groups that are partially unsaturated include, but are not limited to, cyclobutene, cyclopentene, cyclohexene, cyclohexadiene (1,3- and 1,4-isomers), cycloheptene, cycloheptadiene, cyclooctene, cyclooctadiene (1,3-, 1,4- and 1,5-isomers), norbornene, and norbornadiene. When cycloalkyl is a saturated monocyclic C₃₋₈ cycloalkyl, exemplary groups include, but are not limited to cyclopropyl, cyclobutyl, cyclopentyl, cyclohexyl, cycloheptyl and cyclooctyl. When cycloalkyl is a saturated monocyclic C₃₋₆ cycloalkyl, exemplary groups include, but are not limited to cyclopropyl, cyclobutyl, cyclopentyl, and cyclohexyl. Cycloalkyl groups can be substituted or unsubstituted. Unless otherwise specified, “substituted cycloalkyl” groups can be substituted with one or more groups selected from halo, hydroxy, amino, alkylamino, amido, acyl, nitro, cyano, and alkoxy.

Specifically, (C₁-C₆)alkyl can be methyl, ethyl, propyl, isopropyl, butyl, iso-butyl, sec-butyl, pentyl, 3-pentyl, or hexyl; (C₃-C₆)cycloalkyl can be cyclopropyl, cyclobutyl, cyclopentyl, or cyclohexyl; (C₁-C₆)alkoxy can be methoxy, ethoxy, propoxy, isopropoxy, butoxy, iso-butoxy, sec-butoxy, pentoxy, 3-pentoxy, of hexyloxy; (C₁-C₆)alkanoyl can be acetyl, propanoyl or butanoyl; (C₁-C₆)alkoxycarbonyl can be methoxycarbonyl, ethoxyxarbonyl, propoxycarbonyl, isopropoxyxarbonyl, butoxycarbonyl, pentoxycarbonyl, or hexyloxycarbonyl; (C₁-C₆)alkylthio can be methylthio, ethylthio, propylthio, isopropylthio, butylthio, isobutylthio, pentylthio, or hexythio; (C₂-C₆)alkanoyloxy can be acetoxy, propanoyloxy, butanoyloxy, isobutanoyloxy, pentanoyloxy, or hexanoyloxy; aryl can be phenyl, indenyl, or naphthyl; and heteroaryl can be furyl, imidazolyl, triazolyl, triazinyl, oxazoyl, isoxazoyl, thiazolyl, isothiazoyl, pyrazolyl, pyrrolyl, pyrazinyl, tetrazolyl, pyridyl, (or its N-oxide). Thienyl, pyrimidinyl (or its N-oxide), indolyl, isoquinolyl (or its N-oxide) or quinolyl (or its N-oxide).

As used herein, the phrases “dispersed in the matrix of the copolymer” and “dispersed in the matrix of the polymer” mean that an agent, such as a fertilizer agent, is located within the matrix of a copolymer/polymer such that it can be released in a controlled fashion when placed within a crop field. Preferably, the copolymer/polymer matrix comprises a biodegradable polymer.

As used herein, “release” of an agent refers to the delivery of an agent in a form that is bioavailable. For instance, the term “release” includes degradation of a copolymer/polymer in which the agent is incorporated in the copolymer/polymer backbone, or appended to the copolymer/polymer backbone, to release free agent. The term also includes degradation of a copolymer/polymer that entraps molecules of the agent in the matrix of the copolymer/polymer, thereby allowing the free agent to make direct contact with the surrounding environment.

The term “linker” as used herein means a chemical moiety comprising or derived from a group of atoms that is covalently attached to an acid derivative and that is also covalently attached to a second acid derivative. The linker used described herein comprises an alkyl chain that may include any number of carbons, such as C₁₋₂, C₁₋₃, C₁₋₄, C₁₋₅, C₁₋₆, C₁₋₇, C₁₋₈, C₁₋₉, C₁₋₁₀, C₁₋₁₁, C₁₋₁₂, C₂₋₃, C₂₋₄, C₂₋₃, C₂₋₆, C₃₋₄, C₃₋₅, C₃₋₆, C₄₋₅, C₄₋₆ and C₅₋₆. For example, C₁₋₆ alkyl includes, but is not limited to, methyl, ethyl, propyl, isopropyl, butyl, isobutyl, sec-butyl, tert-butyl, pentyl, isopentyl, hexyl, etc. Alkyl can also refer to alkyl groups having up to 20 carbons atoms, such as, but not limited to heptyl, octyl, nonyl, decyl, etc. Unless otherwise specified, alkyl groups can be substituted or unsubstituted. For example, “substituted alkyl” groups can be an alkyl group substituted with one or more groups selected from halo, hydroxy, amino, aminoalkyl, amido, and alkoxy.

As used herein, the term “hydroxy” refers to the moiety —OH.

As used herein, the term “carboxy” refers to the moiety —C(O)OH. A carboxy moiety can be ionized to form the corresponding carboxylate anion.

As used herein, the term “oxo” refers to an oxygen atom that is double-bonded to a compound (i.e., O═).

As used herein, the term “photo-induced polymerization” refers to a polymerization reaction where initiation is triggered by a radiation. Unless stated otherwise, photo-induced may refer to gamma or UV radiation.

As used herein, the term “crosslink” can refer to physical (e.g., intermolecular interactions or entanglements, such as through hydrophobic interactions) or chemical crosslinking (e.g., covalent bonding). Chemical crosslinking may be induced for these hydrogels using ultraviolet (UV) radiation, gamma radiation, an external cross-linking agent, or Fenton and photo-Fenton reactions to obtain chemical hydrogels. This chemical crosslinking may result in a more stable and non-reversible material, wherein the bioactive-based polymer is trapped within the three-dimensional network.

As used herein “tolerance” refers to the ability of a plant to endure a stress without suffering a substantial alteration in metabolism, growth, productivity, and or viability. The stress may be an abiotic stress or a biotic stress.

As used herein “abiotic stress” may refer to a stress that occurs as a result of non-living factors influencing the environment in which the plant lives.

As used herein, “biotic stress” may refer to a stress that occurs as a result of damage done to plants by other living organisms, such as bacteria, viruses, fungi, parasites, beneficial and harmful insects, weeds, and cultivated or native plants.

As used herein drought tolerance (drought resistance) is a general concept, according to the different types of reactions and include drought resistance (dehydration avoidance), drought tolerance and recovery (drought recovery). Here the concept is also extended to erratic rain and temporal lack of water (for instance related to global warming modification of the environment). It should be understood that the terms disclosed herein may be used interchangeably for one another as described herein.

### DETAILED DESCRIPTION OF THE INVENTION

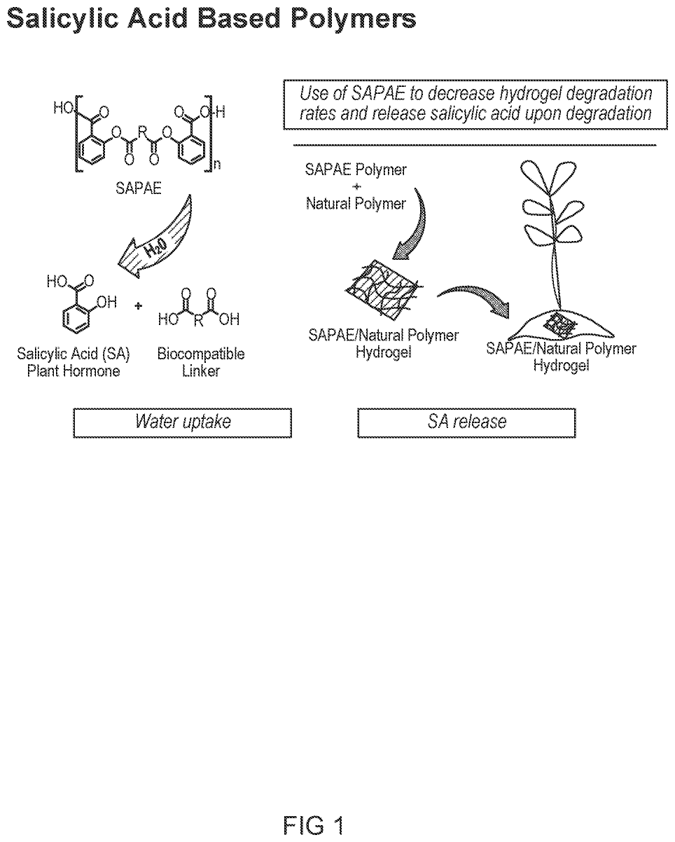

The present invention provides novel bioactive and biocompatible polymers derived from salicylic acid and a biodegradable or biocompatible linker, such as diacyl chloride or itaconic acid, as shown in FIG. 1. It has advantageously been discovered that the presence of itaconic acid in the polymer backbone allows for the formation of hydrogels that can be used to promote growth and/or increase drought or stress tolerance. In one embodiment, the hydrogels can comprise only a salicylic acid/itaconic acid-based polymer, or, alternatively, the hydrogels can comprise a mixture of a salicylic acid/itaconic acid-based polymer with a synthetic polymer or a natural polymer, such as cellulose, starch, chitosan, or other natural polymers known by those skilled in the art. The hydrogels disclosed herein can be applied in the soil or to a seed, seedling, plant, or crop to retain water during drought periods enhancing the plant growth and crop yield. Hydrogels prepared from the salicylic acid/itaconic acid-based polymers will advantageously enhance the ability of the hydrogels to fight drought stress. The homopolymers and copolymers disclosed herein are not only biodegradable but are also bioactive. Additionally, the homopolymers and copolymers can advantageously be used in a singular form to improve the plant, seed, or crop health. For example, the homopolymer or copolymer may be added to the plant, seed, or crop in the form of a powder. The powder can be applied to the root, stem, leave or fruit of the plant. Alternatively, the powder can be mixed into the soil upon planting or seeding to aid in plant growth. Alternatively, the homopolymers or copolymers may be in a microsphere structure, generated via known oil in water solvent evaporation methods, for delivering the salicylic acid to the plant, seed, or crop. Upon degradation (e.g., hydrolysis by exposure to water), the salicylic acid/itaconic acid-based homopolymers and copolymers release salicylic acid to the environment. Salicylic acid, in turn, helps protect against drought stress and promote growth Additionally, the administration of salicylic acid can aid in plant flowering, prevent the formation of mold on fruits (surprisingly even after the fruit has been cut from the plant and exposed to air), and aid in plant growth during normal and drought conditions.

The biocompatible, biodegradable salicylic acid and itaconic acid-based poly(anhydride ester) copolymers disclosed herein may be used to produce a variety of useful products, such as hydrogels, or powders having valuable physical and chemical properties. The poly(anhydride ester) copolymers are useful in applications, such as, for example, the delivery of chemical compounds, such as salicylic acid and fertilizers, the production of hydrogels, and the preparation of coatings. In some embodiments, the biocompatible polymer derived from salicylic acid and a biodegradable linker, such as diacyl chloride or itaconic acid, herein referred to as the homopolymer, may be exogenously applied to a plant in the form of a powder. The exogenous addition of the homopolymer to the seed, plant, or crop can improve the drought resistance, growth rate, and crop production of the treated seed, plant, or crop.

The addition of the homopolymer or a copolymer as disclosed herein as a powder can allow for improved drought resistance, increased growth rate, and increased crop production via a single dose to a plant crop. For example, the addition of a single high dose of salicylic acid (SA) can impart negative effects on a plant, thus resulting in multiple single additions of salicylic acid in lower doses requiring more time input from a farmer and thereby increasing costs. For example, a dose of 0.15 mmol of SA can impart negative growth affects on the seed, plant or crop, however, three independent doses of 0.5 mmol can impart beneficial effects on the seed, plant, or crop. The homopolymer as a powder at a concentration similar to SA at 0.15 mmol can additionally impart beneficial properties on the growth and drought tolerance of the seed, plant, and or crop, obviating the need for the application of multiple doses. The larger dose applications of SA results in a negative impact on the development of the plant, seed, or crop. In some embodiments, the homopolymer powder may have a concentration of from 0.01 mmol to 1.0 mol of salicylic acid within the powder and the powder administered to a plant, crop, or seed. In some embodiments, the homopolymer powder can be added to the seed, plant, or crop to administer a concentration of salicylic acid ranging from 0.01 mmol to 1.0 mmol. For example, the concentration dose of salicylic acid can be 0.05 mmol to 0.10 mmol, from 0.10 mmol to 0.15 mmol, from 0.15 mmol to 0.20 mmol, from 0.20 mmol to 0.25 mmol, from 0.25 mmol to 0.30 mmol, from 0.30 mmol to 0.35 mmol, from 0.35 mmol to 0.40 mmol, from 0.40 mmol to 0.45 mmol, from 0.45 mmol to 0.50 mmol, from 0.50 mmol to 0.55 mmol, from 0.55 mmol to 0.60 mmol, from 0.60 mmol to 0.65 mmol, from 0.65 mmol to 0.70 mmol, from 0.70 mmol to 0.75 mmol, from 0.75 mmol to 0.80 mmol, from 0.80 mmol to 0.85 mmol, from 0.85 mmol to 0.90 mmol, from 0.90 mmol to 0.95 mmol, or from 0.95 mmol to 1.0 mmol. In some embodiments, the homopolymer powder can be added in a single dose at the initiation of seed planting. In some embodiments, the homopolymer powder can be added in multiple doses across the lifespan of the plant. For example, the homopolymer can be added at the initial planting of the seed a first time, and added to the plant at a time later in a seed, plant, or crop life cycle, such as when the plant begins to grow fruit. In some embodiments, the concentration of salicylic acid in the hydrogel may be at a concentration ranging from 0.01 mmol to 1.0 mol. In some embodiments, the hydrogel can be added to the plant in a sufficient quantity such that the concentration of SA within the hydrogel is from 0.05 mmol to 0.15 mmol. In some embodiments, the hydrogel may be added to the plant, seed, or crop to administer a concentration of salicylic acid of from 0.01 mmol to 1.0 mmol. For example, the salicylic acid in the hydrogel may be at a concentration dose of from 0.05 mmol to 0.10 mmol, from 0.10 mmol to 0.15 mmol, from 0.15 mmol to 0.20 mmol, from 0.20 mmol to 0.25 mmol, from 0.25 mmol to 0.30 mmol, from 0.30 mmol to 0.35 mmol, from 0.35 mmol to 0.40 mmol, from 0.40 mmol to 0.45 mmol, from 0.45 mmol to 0.50 mmol, from 0.50 mmol to 0.55 mmol, from 0.55 mmol to 0.60 mmol, from 0.60 mmol to 0.65 mmol, from 0.65 mmol to 0.70 mmol, from 0.70 mmol to 0.75 mmol, from 0.75 mmol to 0.80 mmol, from 0.80 mmol to 0.85 mmol, from 0.85 mmol to 0.90 mmol, from 0.90 mmol to 0.95 mmol, or from 0.95 mmol to 1.0 mmol. In certain embodiments, the concentration of salicylic acid applied to a plant, seed or crop is from 0.001 mmol to 0.600 mmol of SA.

Certain embodiments of the invention provide a copolymer having a backbone, wherein the backbone comprises a) one or more units that comprise a group that will yield a biologically active agent upon hydrolysis of the backbone, such as one or more units of Formula (I) or Formula III; and b) one or more units of Formula II or Formula IV.

In certain embodiments of the invention, the one or more units that comprise a group that will yield a biologically active agent upon hydrolysis of the backbone is a polyanhydride. In certain embodiments of the invention, the polyanhydride is a poly(anhydride ester).

In certain embodiments, the polyanhydride comprises a first group of repeating units of Formula (I) in the backbone and a second group of repeating units of Formula (II) in the backbone.

In certain embodiments, the polyanhydride comprises a first group of repeating units of Formula (III) in the backbone and a second group of repeating units of Formula (IV) in the backbone.

Certain embodiments of the invention provide a homopolymer having a structure comprising Formula (I).

Certain embodiments of the invention provide a homopolymer having a structure comprising Formula (II).

In certain embodiments, the homopolymers and copolymers disclosed herein will yield a biologically active compound upon hydrolysis of the backbone, wherein the backbone of the homopolymer or copolymer has an average molecular weight of about 1,000 daltons to about 700,000 daltons. In certain embodiments, the backbone of the homopolymer or copolymer has an average molecular weight of about 100,000 daltons to about 600,000 daltons. In certain embodiments, the backbone of the homopolymer or copolymer has an average molecular weight about 200,000 daltons to about 500,000 daltons. In certain embodiments, the backbone of the homopolymer or copolymer has an average molecular weight of about 100,000 daltons to about 300,000 daltons. In certain embodiments, the backbone of the homopolymer or copolymer has an average molecular weight of about 50,000 daltons to about 200,000 daltons. In certain embodiments, the backbone of the homopolymer or copolymer has an average molecular weight of about 10,000 daltons to about 30,000 daltons.

In certain embodiments, the biologically active agent is an antimicrobial agent or an antioxidant. In certain embodiments, the biologically active agent is salicylic acid. In some embodiments, the copolymer and active agent are synthetically combined such that the active agent is embedded, entangled, or contained within the polymer. In some embodiments, the active agent is added during the synthesis of the copolymer such that the active agent is entangled, embedded, or contained within the polymer structure. In some embodiments, the active agent may be attached to the backbone via crosslinking to form a pendant chain.

In certain embodiments of the copolymers disclosed herein, the ratio of the (a) one or more units that comprise a group that will yield a biologically active agent upon hydrolysis of the backbone, such as the one or more units of Formula (I), to the (b) one or more units of Formula (II), ranges from between about 10:1 to about 1:10. In certain embodiments, the ratio of the (a) one or more units that comprise a group that will yield a biologically active agent upon hydrolysis of the backbone, such as the one or more units of Formula (I), to the (b) one or more units of Formula (11), ranges from between about 5:1 to 1:5. In certain embodiments, the ratio of the (a) one or more units that comprise a group that will yield a biologically active agent upon hydrolysis of the backbone, such as the one or more units of Formula (I), to the (b) one or more units of Formula (11), ranges from between about 2:1 to 1:2. In certain embodiments, the ratio of the (a) one or more units that comprise a group that will yield a biologically active agent upon hydrolysis of the backbone, such as the one or more units of Formula (I), to the (b) one or more units of Formula (II), is, e.g., 5:1, 4:1, 3:1, 2:1, 1:1, 1:2, 1:3, 1:4, or 1:5. In certain embodiments, the ratio is 1:1 or 2:1.

In certain embodiments, the ratio of the (a) one or more units that comprise a group that will yield a biologically active agent upon hydrolysis of the backbone, such as the one or more units of Formula (III), to the (b) one or more units of Formula (IV), ranges from between about 10:1 to about 1:10. In certain embodiments, the ratio of the (a) one or more units that comprise a group that will yield a biologically active agent upon hydrolysis of the backbone, such as the one or more units of Formula (111), to the (b) one or more units of Formula (IV), ranges from between about 5:1 to 1:5. In certain embodiments, the ratio of the (a) one or more units that comprise a group that will yield a biologically active agent upon hydrolysis of the backbone, such as the one or more units of Formula (III), to the (b) one or more units of Formula (IV), ranges from between about 2:1 to 1:2. In certain embodiments, the ratio of the (a) one or more units that comprise a group that will yield a biologically active agent upon hydrolysis of the backbone, such as the one or more units of Formula (III), to the (b) one or more units of Formula (IV), is, e.g., 5:1, 4:1, 3:1, 2:1, 1:1, 1:2, 1:3, 1:4, or 1:5. In certain embodiments, the ratio is 1:1 or 2:1.

Certain embodiments of the invention provide a block copolymer comprising a) a first block comprising a polyanhydride having a backbone, wherein the backbone comprises one or more units that comprises a group that will yield a biologically active agent upon hydrolysis of the backbone, such as Formula I or Formula III, and b) a second block comprising one or more units of Formula II or Formula IV, wherein R is a linking agent as disclosed herein. In one embodiment, R is a divalent, branched or unbranched, saturated or unsaturated, hydrocarbon chain, having from 1 to 25 carbon atoms, and wherein one or more of the carbon atoms is optionally replaced by (—O—), (—NR¹—) or phenylene, and wherein the chain is optionally substituted on carbon with one or more substituents selected from the group consisting of (C₁-C₆)alkoxy, (C₃-C₆)cycloalkyl, (C₁-C₆)alkanoyl, (C₁-C₆)alkanoyloxy, (C₁-C₆)alkoxycarbonyl, (C₁-C₆)alkylthio, azido, cyano, nitro, halo, hydroxy, oxo, carboxy, aryl, aryloxy, heteroaryl, and heteroaryloxy, wherein each R¹ is independently selected from H or (C₁-C₆)alkyl. In one embodiment, the linker R includes, but is not limited to, the following:

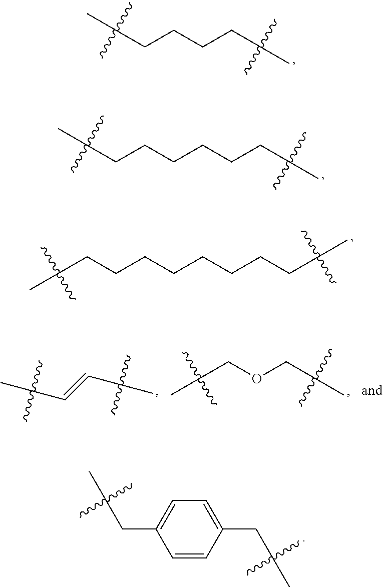

In certain embodiments, the homopolymers and copolymers disclosed herein can be synthesized to achieve the desired mechanical properties and release profiles. In certain embodiments, a homopolymer as disclosed herein can be crosslinked via itself to form a hydrogel. Similarly, in certain embodiments, a copolymer as disclosed herein can be crosslinked via itself to form a hydrogel. In certain embodiments, a homopolymer or a copolymer disclosed herein can be crosslinked with a natural polymer to form a hydrogel. In certain embodiments, the natural polymer includes, but is not limited to, sodium carboxy methyl cellulose, starch, cellulose derivative, chitosan, etc. Those of ordinary skill in the art will appreciate that other natural polymers can be used to form hydrogels with the homopolymer and copolymers disclosed herein. In certain embodiments, the natural polymer is a copolymer or blend of two or more natural polymers.

In certain embodiments, the homopolymer or copolymer can be crosslinked with a second synthetic copolymer to form a hydrogel. In a certain embodiment, the synthetic polymer may be a hydrophilic polymer. In certain embodiments, the hydrophilic polymer includes, but is not limited to, poly(N-vinyl-2-pyrrolidone), polyvinylpolypyrrolidone, poly(vinyl alcohol), polyurethane, or poly(ethylene oxide). Those of ordinary skill in the art will appreciate that other synthetic polymers and, in particular, other hydrophilic polymers can be used to form hydrogels with the homopolymer and copolymers disclosed herein.

In certain embodiments, the hydrophilic polymer as described herein has an average molecular weight of about 40,000 daltons to about 2,000,000 daltons. In certain embodiments, the hydrophilic polymer as described herein has an average molecular weight of about 100,000 daltons to about 2,000,000 daltons. In certain embodiments, the hydrophilic polymer as described herein has an average molecular weight of about 500,000 daltons to about 2,000,000 daltons. In certain embodiments, the hydrophilic polymer as described herein has an average molecular weight of about 750,000 daltons to about 2,000,000 daltons. In certain embodiments, the hydrophilic polymer as described herein has an average molecular weight of about 1,000,000 daltons to about 2,000,000 daltons. In certain embodiments, the hydrophilic polymer as described herein has an average molecular weight of about 1.500.000 daltons to about 2,000,000 daltons. In certain embodiments, the hydrophilic polymer as described herein has an average molecular weight of about 1,500,000.

In certain embodiments, the crosslinking agent may be aluminum sulfate, Iron(III) chloride, Iron(II) chloride, calcium chloride, or other suitable chloride derivatives.

In certain embodiments, the ratio of the poly(anhydride ester) to the hydrophilic polymer ranges between about 1:10 to about 10:1. In certain embodiments, the ratio of the poly(anhydride ester) to the hydrophilic polymer ranges between about 1:10 to about 4:6. In certain embodiments, the ratio of the poly(anhydride ester) to the hydrophilic polymer ranges between about 1:10 to about 3:7. In certain embodiments, the ratio of the poly(anhydride ester) to the hydrophilic polymer ranges between about 1:10 to about 2:8. In certain embodiments, the ratio of the poly(anhydride ester) to the hydrophilic polymer ranges between about 1:10. In certain embodiments, the ratio of the poly(anhydride ester) to the hydrophilic polymer ranges between about 10:1. In certain embodiments, the ratio of the poly(anhydride ester) to the hydrophilic polymer ranges between about 2:8. In certain embodiments, the ratio of the poly(anhydride ester) to the hydrophilic polymer ranges between about 3:7. In certain embodiments, the ratio of the poly(anhydride ester) to the hydrophilic polymer ranges between about 4:6. In certain embodiments, the ratio of the poly(anhydride ester) to the hydrophilic polymer ranges between about 1:1.

In certain embodiments, the ratio of the poly(anhydride ester) to the natural polymer ranges between about 1:10 to about 10:1. In certain embodiments, the ratio of the poly(anhydride ester) to the natural polymer ranges between about 1:10 to about 4:6. In certain embodiments, the ratio of the poly(anhydride ester) to the natural polymer ranges between about 1:10 to about 3:7. In certain embodiments, the ratio of the poly(anhydride ester) to the natural polymer ranges between about 1:10 to about 2:8. In certain embodiments, the ratio of the poly(anhydride ester) to the natural polymer ranges between about 1:10. In certain embodiments, the ratio of the poly(anhydride ester) to the hydrophilic polymer ranges between about 10:1. In certain embodiments, the ratio of the poly(anhydride ester) to the natural polymer ranges between about 2:8. In certain embodiments, the ratio of the poly(anhydride ester) to the natural polymer ranges between about 3:7. In certain embodiments, the ratio of the poly(anhydride ester) to the natural polymer ranges between about 4:6. In certain embodiments, the ratio of the poly(anhydride ester) to the natural polymer ranges between about 1:1.

Additional molecules, synthetic or natural, may be incorporated in the homopolymer powders or hydrogels described herein to achieve enhanced mechanical or biological properties. In some embodiments, the added compound may be an active agent. The active agent can include, but is not limited to, a fertilizer, a plant hormone, a pesticide, an antioxidant, an antimicrobial, etc. For example, a fertilizer may be incorporated into the blended solution for hydrogel production, resulting in a material with dual release of bioactive molecules, such as salicylic acid, as well as, for example, a fertilizer, thereby providing dual purpose hydrogels.

In some embodiments, the fertilizer may be, for example, urea, monopotassium-phosphate, Nitrogen-phosphorous-potassium (NPK) fertilizers, or other fertilizers known to and used by those of skill in the art. In some embodiments, the plant hormone can be, for example, those plant hormones that auxiliate on plant growth. For example, the plant hormone can be, for example, an auxin, cytokinins, or gibberllins. An antioxidant may be added to the homopolymer or hydrogel. In some embodiments, the antioxidant can be, for example, ferulic acid. In some embodiments, the pesticide can include, but is not limited to, chlorpyrifos, 2,4-dichlorophenoxyacetate, acetamiprid, bifenthrin, naled, azadirachtin, fipronil, resmethrin, chlordane, cypermethrin, DDT, carbofuran, acetochlor, malathion, imidacloprid, carbaryl, acephate, carbamate, aldicarb, chlorothalonil, pennethrin, or boric acid.

In some embodiments, the homopolymer or copolymer may be added to the plant, seed, or crop as a thin film. For example, the thin film may be placed on top of the soil, may be around the plant stem, may encase a portion of the plant stem, or may coat a small section of a plant leaf or bud. In some embodiments, the hydrogel may be produced in the form of small micro or nanostructures. For example, the hydrogel may be produced as microparticles or nanoparticles having a spherical, rod, cylindrical shape. The micro or nano beads may be added to the soil and mixed into the soil bed under or around the plant. In some embodiments, a seed may be encapsulated via the thin film.

Accordingly, in certain embodiments, the hydrogel further comprises a fertilizer, urea, or monopotassium-phosphate dispersed in the hydrogel. In certain embodiments, the molecule incorporated into the hydrogel may be the bioactive molecule yielded by hydrolysis of the polymer backbone.

In certain embodiments, the poly(anhydride ester) is chemically crosslinked with a hydrophilic polymer.

In certain embodiments, the poly(anhydride ester) is covalently crosslinked with the hydrophilic polymer.

In certain embodiments, the poly(anhydride ester) is ionically crosslinked with a natural polymer, a synthetic polymer, a hydrophilic polymer, or a combination thereof.

In certain embodiments, the poly(anhydride ester) is crosslinked with the hydrophilic polymer using a free radical mechanism.

In certain embodiments, the poly(anhydride ester) is a salicylic acid-based copolymer and may be crosslinked with a hydrophilic polymer.

In certain embodiments, the poly(anhydride ester) is a salicylic acid-based copolymer and may be crosslinked via itaconic acid with a hydrophilic polymer.

In certain embodiments, a first poly(anhydride ester) is a salicylic acid-based copolymer and may be crosslinked with a second poly(anhydride ester) is a salicylic acid-based copolymer.

In certain embodiments, the hydrogel may be formed from a salicylic acid-based copolymer and may be crosslinked with carboxymethyl cellulose. In certain embodiments, the crosslinking agent may be calcium chloride. In certain embodiments, the crosslinking agent is iron chloride. In certain embodiments, the crosslinking agent may be aluminum sulfate. In certain embodiments, the carboxymethyl cellulose crosslinked with salicylic acid-based poly(anhydride ester) to form a hydrogel may increase the physical shape retention of the hydrogel. In certain embodiments, the natural polymer crosslinked with salicylic acid-based poly(anhydride ester) may retain water for an extended duration. In certain embodiments, the hydrogel formed from crosslinking carboxymethyl cellulose with the salicylic acid-based poly(anhydride ester) copolymer may improve plant growth. In certain embodiments, the hydrogel formed from the copolymer of salicylic acid-based poly(anhydride ester) and the natural polymer may increase water retention of the hydrogel compared to a hydrogel formed from the copolymer of salicylic acid-based poly(anhydride ester) crosslinked to a second unit of the salicylic acid-based poly(anhydride ester).

As described herein, the synthesis of the hydrogels may be prepared as films by one-pot, green solvent free chemistry, or traditional chemistry methods. As described herein, the materials may be produced at varying ratios to achieve the desired formulation.

Accordingly, certain embodiments of the invention provide a method of making a hydrogel as described herein, comprising one-pot polymer synthesis wherein the one pot polymer synthesis improves synthetic efficiency due to a reduced number of steps and decreases reaction time significantly. Additionally, synthesis involving the use of solvent can often leave solvent trapped in the polymer matrix making it at times unsuitable for agricultural purposes.

As described herein, the synthesis of the copolymers used to generate hydrogels may be prepared via traditional chemistry techniques or via green esterification methods using, for example, the dried dowex (H⁺)/NaI approach.

Certain embodiments provide a method comprising cross-linking the salicylic acid-based poly(anhydride ester) with the hydrophilic polymer using ultraviolet radiation, gamma radiation or an external cross-linking agent.

In certain embodiments, the itaconic acid may be synthesized from agricultural waste. In certain embodiments, the itaconic acid may be purchased for use. In certain embodiments, the itaconic acid may be used as a cross-linking moiety.

Certain embodiments provide a method of making a hydrogel as described herein.

Certain embodiments provide a hydrogel prepared as described herein.

Certain embodiments provide a method for combating drought stress and promoting plant growth and production, comprising contacting a plant hydrogel as described herein.

In certain embodiments, the bioactive molecule yielded upon hydrolysis of the polymer backbone has an antimicrobial, antioxidant, or analgesic effect. In one embodiment, the bioactive molecule is salicylic acid.

In certain embodiments, the copolymers described herein improve stress tolerance of a plant. In certain embodiments the seed of the plant may be coated with the hydrogel composition described herein.

In certain embodiments, the composition of the hydrogel is adapted to be applied on a plant. In certain embodiments, the hydrogel is adapted to be sprayed on the plant. In another embodiment, the composition of the hydrogel as described herein is adapted to coat parts of the plant. In certain embodiments, the composition of the hydrogel is adapted to form a coating hydrogel, such as a seed coating hydrogel.

In certain embodiments, the composition of the invention may be coated on the plant before planting, coated on the seed before planting, or coated on the plants after planting.

In certain embodiments, the hydrogel may be applied on the plant. In certain embodiments, the hydrogel composition may be applied on the aerial parts of the plant, such as the leaves and stems. In another embodiment, the hydrogel composition may be applied on underground parts of the plant, such as for example on roots.

In certain embodiments, the hydrogel composition is treated with a fertilizer or pesticide or both before being added to the plant and/or seed. In certain embodiments, the hydrogel composition described herein may provide a controlled release of fertilizer or pesticide to the aerial sections of the plant. In certain embodiments, the hydrogel composition described herein may provide a controlled release of fertilizer or pesticide to the underground sections of the plant, such as the roots.

In certain embodiments, the hydrogel composition upon being dissolved, release small molecules that may treat drought stress in plants, for example, the fertilizer, the pesticide, or salicylic acid.

### EXAMPLES

### Homopolymer and Copolymer Characterization

Structural confirmation of the synthesized compounds is performed by proton nuclear magnetic resonance (¹H NMR) and by attenuated total reflectance-Fourier transform infrared spectroscopy (ATR-FTIR). For ¹H NMR, 5-10 mg of the sample is dissolved in DMSO-d6 and analyzed by a Bruker Avance 600 MHz or 300 MHz (16 scans). The Thermo Nicolet 6700 FTIR, is used for ATR-FTIR analysis and the samples are directly placed at the instrument crystal. Thermal properties such as glass transition temperature (T_{g}), melting temperature (Tₘ) and decomposition temperature (Td) are obtained by differential scanning calorimetry (DSC) and thermogravimetric analysis (TGA) under N₂ atmosphere. For TGA, samples are heated up to 600° C. at 10° C./min, whereas for DSC, samples undergo a heat-cool-heat cycle from −25° C.-200° C. unless prevented by the degradation temperature of the samples. Heating and cooling rates are maintained at 10° C./min. Polymers number-average molecular weight (Mₙ), weight-average molecular weight (M_{w}) and polydispersity index (PDI) are obtained by gel permeation chromatography (GPC) using a TOSOH EcoSEC all in one GPC system equipped with two sample column in tandem (TOSOH TSKgel GMH_{HR}-N 7.8 mm I.D.×30 cm, 5 μm (2x)), a reference column (TSKgel SuperH-RC 6.0 mm I.D.×15 cm, 4 μm) both at 30° C., and a dual flow IR detector. Samples are dissolved in DCM and filtered through a PVDF (0.45 μm) syringe filter prior to the analysis. DCM is used as mobile phase at 0.6 mL/min. Polymers that may not be soluble in DCM are dissolved in an appropriate solvent. Polystyrene is used as a standard.

### Hydrogel Characterization

Hydrogels morphology are evaluated by scanning electron microscopy (SEM) after hydrogels are completely dried. Alternatively, an optical microscope may be employed to investigate the physical characteristics of the hydrogel. Mechanical properties of the hydrogels are obtained by rheology and mechanical test experiments. Degree of swelling are obtained via Eqn 1.

$$Degree of swelling = \frac{Ws - Wd}{Wd} \qquad ( 1 )$$

For swelling experiments, hydrogels are weighed after completely drying (Wd) and are then immersed in an excess of water for a predetermined amount of time. At pre-determined time points, the excess water is removed by filtration and the swelled hydrogel is weighed (Ws). Fresh water is added to each hydrogel until the experiment is complete.

The hydrogels may be completely dried after swelling tests to calculate the percent of gel content according to Eqn 2

$$Percent of gel content = \frac{Wda}{Wdb} \qquad ( 2 )$$

wherein Wda is the weight of the dried hydrogel after swelling and wdb is the dried weight before swelling experiments. Drying kinetics are evaluated to determine the water content and the rate of water loss by weighing the hydrogels dried under controlled temperature and vacuum conditions at pre-determined time points. DSC and TGA are used to determine the hydrogels thermal properties and the characterization techniques for the copolymers is employed. Degradation studies of the hydrogels are performed using the Suntest CPS+ to mimic the degradation conditions in agricultural fields. Salicylic acid release is monitored by ultraviolet/visible spectroscopy (UV-vis). Encapsulation efficiency of fertilizers/pesticides and release studies were performed using either HPLC or UV-vis. Evaluation of the hydrogel performance on water deprived plants is performed with few of the most promising hydrogel compositions considering the appropriate controls.

### Example 1

Synthetic scheme of salicylate/itaconic acid-based poly(anhydride ester) homopolymer (SAITAPAE): a) Esterification reaction between salicylic acid and Itaconyl chloride forming the SAITA diacid; and b) synthesis of the homopolymer (SAITAPAE) via melt-condensation polymerization

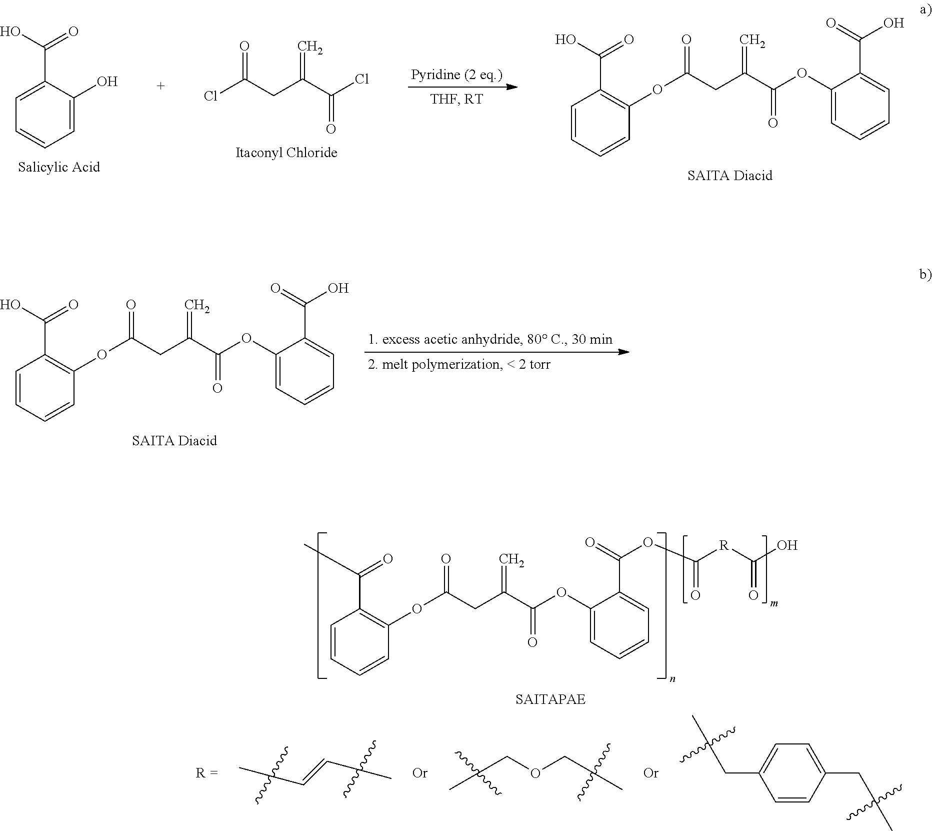

Preparation of 2,2′-((2-methylenesuccinyl)bis(oxy))dibenzoic acid (SAITA Diacid). Salicylic acid (SA) is dissolved in tetrahydrofuran (THF, 100 mL) under inert gas in a round-bottomed flask (RBF). Pyridine is added via syringe and the reaction magnetically stirred for min at room temperature. Itaconyl chloride is dissolved in 15 mL of THF and transferred, via an addition funnel, to the SA-TH-F solution dropwise for 1 hour. After stirring overnight at RT, the remaining solids were re-dissolved in ethyl acetate (50 mL) and transferred to a separatory funnel. Extraction was performed with 1M hydrochloric acid (HCL, 50 mL) and the organic layer dried with magnesium sulfate (MgSO₄). Solvent removal was performed under reduced pressure before the SAITA diacid purification was performed via column chromatography.

In an alternative, the production of SAITA diacid may be performed via green esterification methods using dried dowex (H⁺)/NaI approach. In brief. Amberchrom® 50WX8 hydrogen form (200400 mesh) resin is pre-treated with 2M HCl under stirring for 30 min at room temperature. The solution is then vacuum filtered and the solid washed with DI-water until the filtrate is neutral pH. The resin is dried overnight (120° C.) prior to the esterification reaction.

In a round bottom flask, salicylic acid (2-3 eq.), itaconic acid (1 eq.), the pre-treated ion exchange resin (1-10% w/v) and toluene would be added and refluxed until all itaconic acid is consumed. The acid resin is be filtered out and washed with toluene. The filtrate is then washed with sodium bicarbonate (NaHCO₃) and the organic layer is dried in MgSO₄. The toluene is then removed under reduced pressure. The product is the purified by column chromatography as described in the first approach.

Preparation of SAITAPAE copolymer. SAITA diacid is stirred in excess acetic anhydride at 80° C. under inert gas in 50 mL RBF. Both diacid copolymers undergo acetylation prior to polymerization. Excess acetic acid is removed in vacuo to acquire activated monomer. Monomer is placed under vacuum (<2 Torr) and brought to 175° C. with active stirring at 120 rpm with overhead stirrer. Reaction proceeds until vitrification or polymer viscosity is attained. Upon completion, reaction is cooled to RT, dissolved in DCM, and precipitated in 400 mL chilled diethyl ether. Resulting polymer is isolated via decantation or vacuum filtration and dried under vacuum.

In certain embodiments, R may be an alkyl chain that may include any number of carbons, such as C₁₋₂, C₁₋₃, C₁₋₄, C₁₋₅, C₁₋₆, C₁₋₇, C₁₋₈, C₁₋₉, C₁₋₁₀, C₁₋₁₁, C₁₋₁₂, C₂₋₃, C₂₋₄, C₂₋₅, C₂₋₆, C₃₋₄, C₃₋₅, C₃₋₆, C₄₋₅, C₄₋₆ and C₅₋₆. For example, C₁₋₆ alkyl includes, but is not limited to, methyl, ethyl, propyl, isopropyl, butyl, isobutyl, sec-butyl, tert-butyl, pentyl, isopentyl, hexyl, etc. Alkyl can also refer to alkyl groups having up to 20 carbons atoms, such as, but not limited to heptyl, octyl, nonyl, decyl, etc. Unless otherwise specified, alkyl groups can be substituted or unsubstituted. For example, “substituted alkyl” groups can be an alkyl group substituted with one or more groups selected from halo, hydroxy, amino, aminoalkyl, amido, and alkoxy.

### Example 2

Synthetic scheme of salicylate-based poly(anhydride ester) copolymerized with itaconic acid (SAPAE-ITA): a) Esterification reaction between salicylic acid and a diacyl chloride forming the salicylate-based diacid; and b) synthesis of the copolymer (SAPAE-ITA) via melt-condensation polymerization.

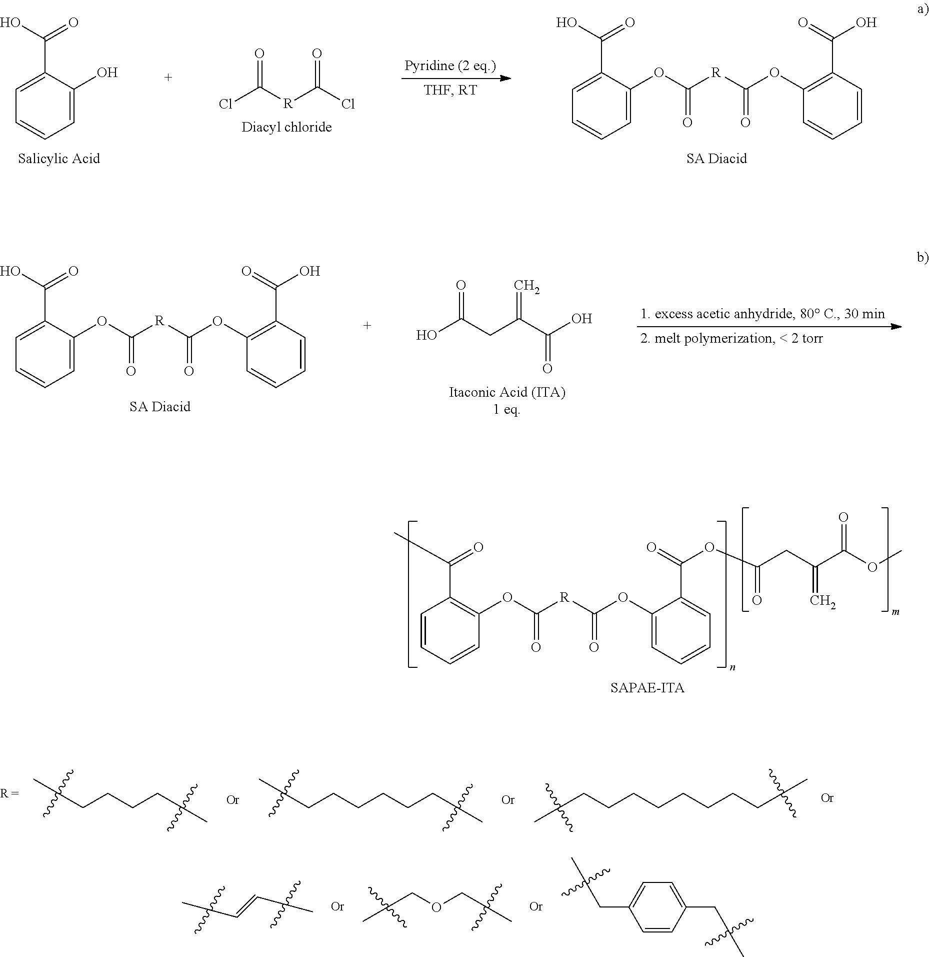

Preparation of SA (Adipic) Diacid. Salicylic acid (SA) is dissolved in tetrahydrofuran (THF) under inert gas in a round-bottomed flask (RBF). Pyridine is added via syringe and the reaction magnetically stirred for 15 min at room temperature. Diacyl chloride is added dropwise to the reaction solution over 1 hr. After stirring overnight at RT. Crude diacid is then dissolved in acetone with heating and reprecipitated in 5-fold excess hexanes with continued stirring and cooling to RT. Product is then isolated via vacuum filtration and dried in vacuum oven at 60° C. for >12 hrs. The resulting product is SA diacid shown in (a).

Preparation of SAPAE-ITA copolymer. SA diacid is stirred in excess acetic anhydride at 80° C. under inert gas in an RBF. Excess acetic acid is removed in vacuo to acquire activated monomer. Monomer is placed under vacuum (<2 Torr) and brought to 175° C. with active stirring at 120 rpm with overhead stirrer. Reaction proceeds until vitrification or polymer viscosity is attained. Upon completion, reaction is cooled to RT, dissolved in DCM, and precipitated in 400 mL chilled diethyl ether. Resulting polymer is isolated via decantation or vacuum filtration and dried under vacuum.

In certain embodiments. R may be an alkyl chain that may include any number of carbons, such as C₁₋₂, C₁₋₃, C₁₋₄, C₁₋₅, C₁₋₆, C₁₋₇, C₁₋₈, C₁₋₉, C₁₋₁₀, C₁₋₁₁, C₁₋₁₂, C₂₋₃. C₂₋₄, C₂₋₅, C₂₋₆, C₃₋₄, C₃₋₅, C₃₋₆, C₄₋₅, C₄₋₆ and C₅₋₆. For example, C₁₋₆ alkyl includes, but is not limited to, methyl, ethyl, propyl, isopropyl, butyl, isobutyl, sec-butyl, tert-butyl, pentyl, isopentyl, hexyl, etc. Alkyl can also refer to alkyl groups having up to 20 carbons atoms, such as, but not limited to heptyl, octyl, nonyl, decyl, etc. Unless otherwise specified, alkyl groups can be substituted or unsubstituted. For example, “substituted alkyl” groups can be an alkyl group substituted with one or more groups selected from halo, hydroxy, amino, aminoalkyl, amido, and alkoxy.

In certain embodiments, R may be an alkene or cycloalkene. In certain embodiments, R may be a (C₁-C₆)alkoxy can be methoxy, ethoxy, propoxy, isopropoxy, butoxy, iso-butoxy, sec-butoxy, pentoxy, 3-pentoxy, of hexyloxy; (C₁-C₆)alkanoyl can be acetyl, propanoyl or butanoyl; (C₁-C₆)alkoxycarbonyl can be methoxycarbonyl, ethoxyxarbonyl, propoxycarbonyl, isopropoxyxarbonyl, butoxycarbonyl, pentoxycarbonyl, or hexyloxycarbonyl; (C₁-C₆)alkylthio can be methylthio, ethylthio, propylthio, isopropylthio, butylthio, isobutylthio, pentylthio, or hexythio; (C₂-C₆)alkanoyloxy can be acetoxy, propanoyloxy, butanoyloxy, isobutanoyloxy, pentanoyloxy, or hexanoyloxy; aryl can be phenyl, indenyl, or naphthyl; and heteroaryl can be furyl, imidazolyl, triazolyl, triazinyl, oxazoyl, isoxazoyl, thiazolyl, isothiazoyl, pyrazolyl, pyrrolyl, pyrazinyl, tetrazolyl, pyridyl, (or its N-oxide). Thienyl, pyrimidinyl (or its N-oxide), indolyl, isoquinolyl (or its N-oxide) or quinolyl (or its N-oxide).

### Example 3

Proposed preparation of SAITA or SAPAE-ITA Hydrogel. Hydrogels may be synthesized via dissolving in an organic solvent followed by purging under nitrogen for 1 hour. Following 3% w/w of Irgacure 2959 (initiator) will be added to the solution and stirred at room temperature. The solution is then transferred to an RBF and cured under a UV lamp (365 nm). The hydrogel is then washed in a solvent mixture (e.g., acetone:water 50:50) to remove residual materials. The hydrogels are preferentially composed of salicylic-acid based polymers (homopolymer or copolymer).

### Example 4

Proposed preparation of SAITAPAE copolymer with natural polymers as hydrogel. To increase the water absorbency of the hydrogel and further increase the biocompatibility, the homopolymer or copolymer may be combined with a natural polymer, such as carboxymethyl cellulose, starch, or chitosan. The presence of natural polymers that are soluble in water would promote a higher water uptake by the hydrogel network.

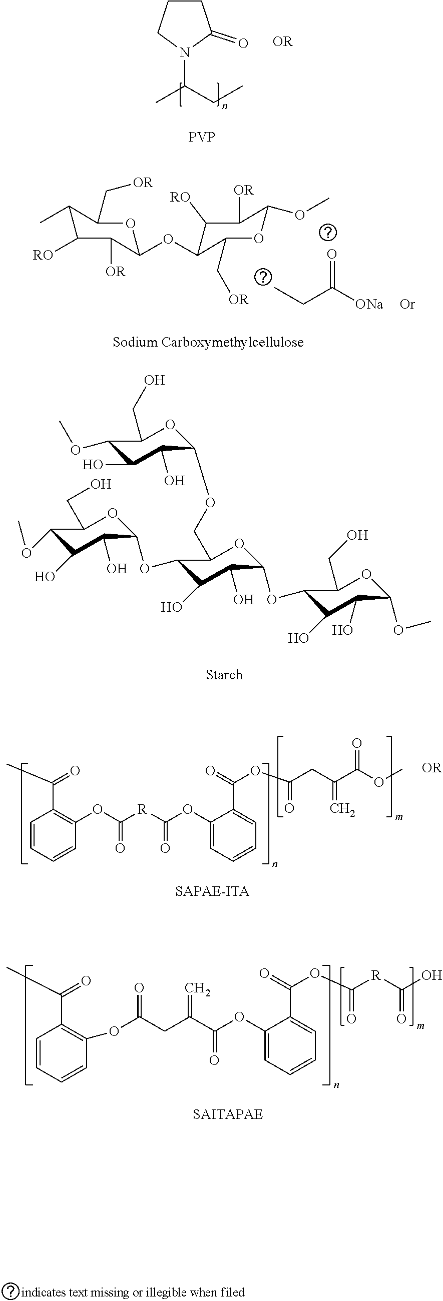

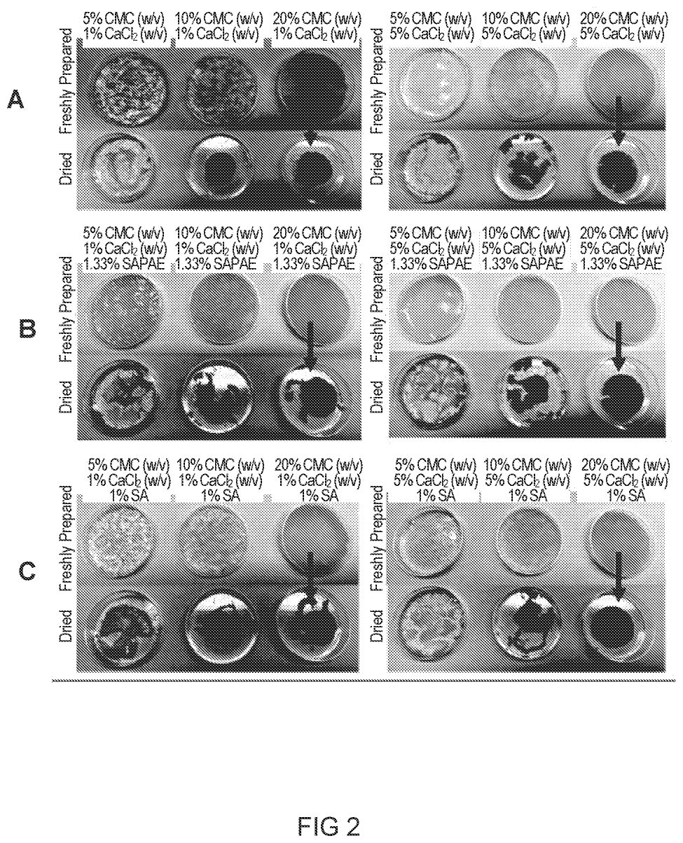

FIG. 2A provides photographs of 5%, 10% or 20% (w/v) CMC with CaCl₂ crosslinking agent. FIG. 2A demonstrates the impact that CaCl₂ has on the drying or freshly prepared hydrogel. The increase of the crosslinking agent provides a hydrogel that appears to crumble upon drying when compared to the lower percentage of the crosslinking agent.

FIG. 2B provides photographs of 5%, 10% or 20% (w/v) CMC with CaCl₂ crosslinking agent and incorporation of SAPAE homopolymer. As demonstrated from the photographs, the incorporation of SAPAE into the hydrogel provides a less uniform hydrogel structure when compared to FIG. 2A.

FIG. 2C provides photographs of 5%, 10% or 20% (w/v) CMC with CaCl₂ crosslinking agent and the incorporation of salicylic acid. As demonstrated by the photographs, the incorporation of salicylic acid had minimal impact on the visual properties of the hydrogel when compared to FIG. 2A. These results demonstrate that the incorporation of SA or SAPAE had no adverse visual effects on the physical state of the hydrogel after being dried when compared to the control group (FIG. 2A).

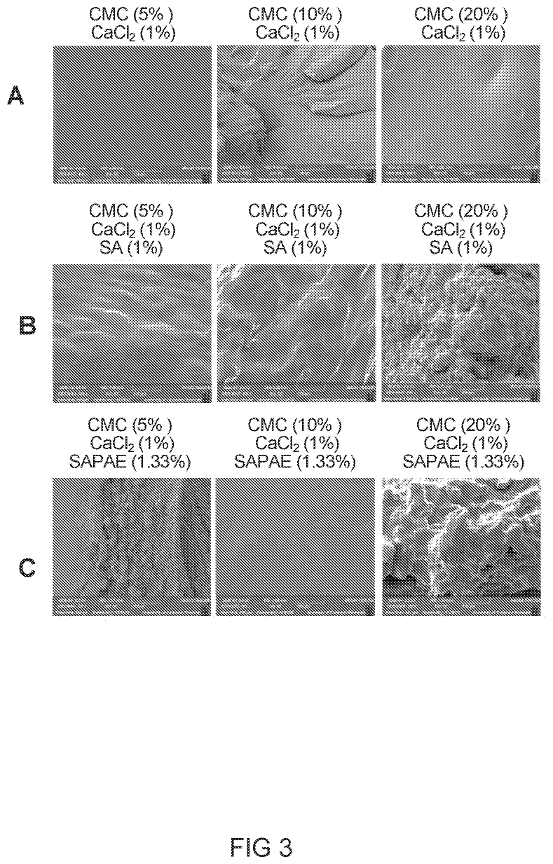

FIG. 3 provides photographs of the surface topography of the hydrogel with no salicylic acid or SAPAE (FIG. 3A), with the incorporation of salicylic acid (FIG. 3B), or with the incorporation of SAPAE homopolymer (FIG. 3C). Scanning electron microscopy images demonstrate that the surface topography changes with the incorporation of SAPAE or SA into the hydrogel (FIG. 3B and FIG. 3C, respectively, when compared to FIG. 3A). These results demonstrate that the morphology containing SAPAE or SA is less smooth or homogenous when compared to the CMC hydrogel.

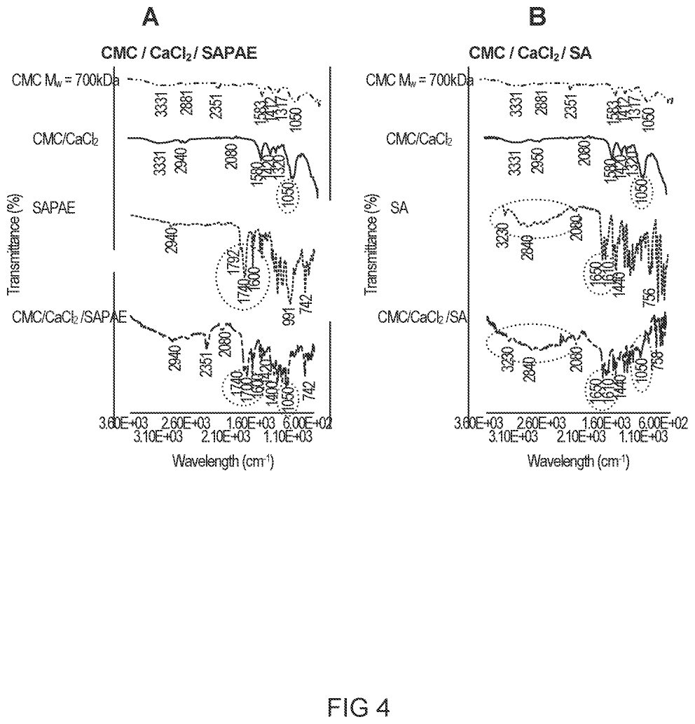

FIG. 4A provides ATR-FTIR illustrations for the CMC, the CMC with CaCl₂), SAPAE, and the hydrogel after formation. The results demonstrate that the SAPAE has distinguishable cm⁻¹ at 1792, 1740, and 1600 with no broad bands around 2300 cm⁻¹.

FIG. 4B provides ATR-FTIR illustrations for the CMC. CMC with CaCl₂, salicylic acid, and of the hydrogel after formation. The results demonstrate that SA in the hydrogel with CMC has distinguishable bands at 3230, 2840, and 2080 cm⁻¹ when compared to the hydrogel with SAPAE. These results demonstrate that ATR-FTIR may be an acceptable tool for distinguishing the chemical makeup of the hydrogel.

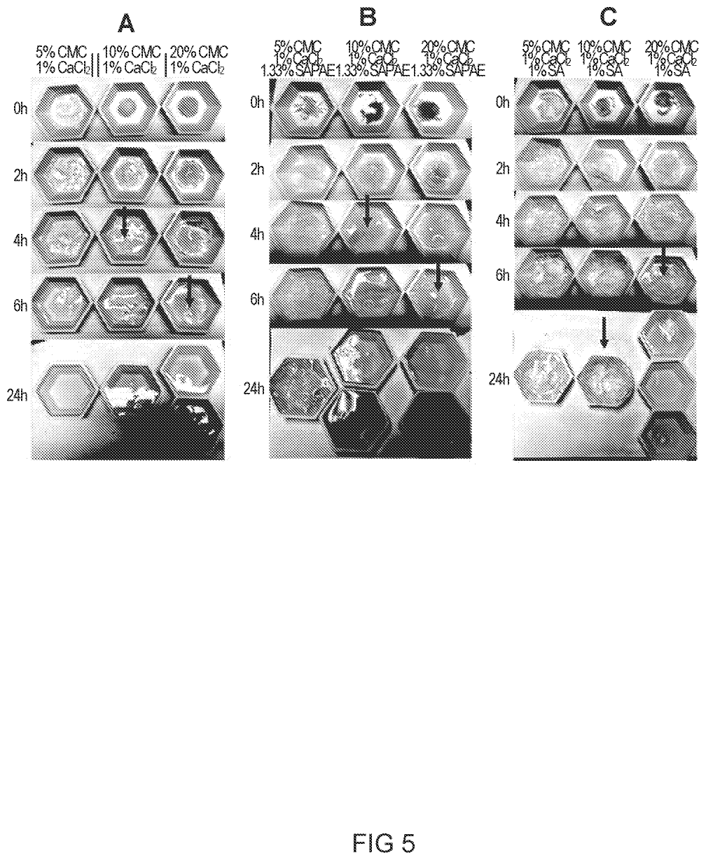

FIG. 5A provides photographs of degree of swelling for 5%, 10% or 20% (w/v) CMC with CaCl₂ crosslinking agent at time points 0, 2, 4, 6, and 24 hours. As demonstrated by the photographs, the hydrogel reached its maximum swelling around the 24-hour mark. The hydrogel with 20% CMC had a higher degree of swelling visually than did the 10% CMC hydrogel.

FIG. 5B provides photographs of degree of swelling for 5%, 10% or 20% (w/v) CMC with CaCl₂ crosslinking agent at time points 0, 2, 4, 6, and 24 hours with the incorporation of SAPAE homopolymer. The photographs demonstrate that the more CMC added to the hydrogel, the lower the swelling capacity with the incorporation of SAPAE polymer.

FIG. 5C provides photographs of degree of swelling for 5%, 10% or 20% (w/v) CMC with CaCl₂ crosslinking agent at time points 0, 2, 4, 6, and 24 hours with the incorporation of salicylic acid. These results demonstrate that the hydrogel with the incorporation of SA or SAPAE may swell faster than the hydrogel with CMC and CaCl₂. The results demonstrate that the incorporation of SAPAE or SA to the hydrogel formulation may impart beneficial swelling characteristics to the hydrogel.

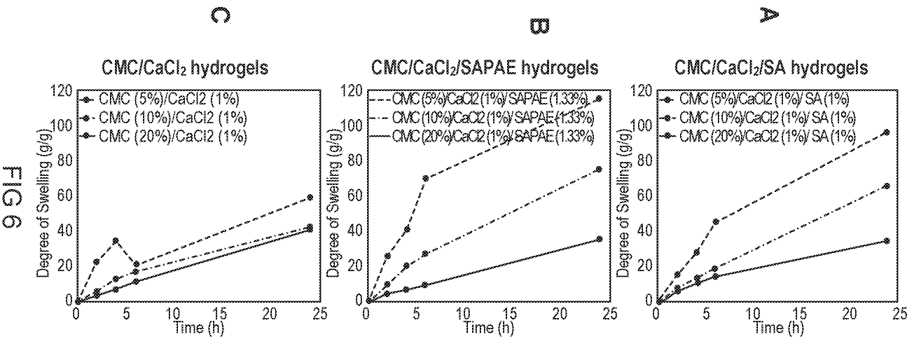

FIG. 6A provides a graph for the degree of swelling of a hydrogel formed from CMC and crosslinked with CaCl₂. The graph demonstrates that when more CMC is added to the hydrogel, the degree of swelling decreased. Additionally, the degree of swelling decreased as the % of CMC increased. As can be seen from the graph, 20% CMC had the maximum degree of swelling around 40 (g/g) while the 5% CMC hydrogel was around 60 (g/g) after 24 hours.

FIG. 6B provides a graph of the degree of swelling of a hydrogel formed from CMC, SAPAE and crosslinking agent CaCl₂. As seen in the graph, the hydrogel with 5% CMC and SAPAE demonstrated a degree of swelling maximum of over 100 (g/g) at the 24-hour mark while increasing the CMC to 10% and 20% decreased the degree of swelling of the hydrogel.

FIG. 6C provides a graph of the degree of swelling of a hydrogel formed from CMC, crosslinking agent CaCl₂, and salicylic acid. As can be seen from the data collected in FIG. 6C, the degree of swelling demonstrated a similar trend to that of FIGS. 6A and 6B. The higher the amount of CMC, the lower the degree of swelling. Additionally, the hydrogel with SA did not demonstrate the same trend as SAPAE in FIG. 6B (i.e., the degree of swelling was lower when compared to FIG. 6B.

These results demonstrate that the higher the amount of CMC, the hydrogel may retain their physical shape for a longer time while decreasing their degree of swelling. Additionally, the results demonstrate that the higher the CaCl₂ crosslinking agent concentration is, the hydrogel may retain more water for a longer period of time. The hydrogels with the incorporation of SA or SAPAE may have improved swelling behavior when compared to CMC hydrogels.

### Example 5

The disclosed hydrogels can be used as an agent transport mechanism. Incorporation of fertilizers or pesticides is performed by simple mixing of the fertilizer or pesticide with the polymer before the chemical cross-linking reaction takes place or by soaking the hydrogel in saturated solutions containing the molecule or active agent of interest. Upon exposure to, for example, a plant, the hydrogel will decompose in the presence of water and will release the fertilizer or pesticide in combination with bioactive salicylic acid onto the plant, thus promoting plant growth and/or drought or stress tolerance.

### Example 6

Exogenous application of salicylic acid favors plants under stress by regulating processes such as photosynthesis, membrane permeability, nutrient uptake, transpiration, and the activity of antioxidant enzymes. An environmentally safe salicylic acid derived poly(anhydride ester) (SAPAE) that hydrolytically degrades to release salicylic acid in a controlled manner has been developed. Here, the effect of the controlled release of salicylic acid in plants under healthy and drought conditions was investigated by comparing the exogenous application of SAPAE polymer with the direct application of salicylic acid to the soil of micro-tom tomato plants. The exogenous application of all compounds was performed directly in the powder form to the soil at comparable concentrations during the seedling stage (˜30 days of the life cycle). Plant growth and mortality was monitored from the day the plants were treated with SAPAE or salicylic acid through the remaining days of the plant cycle (total plant cycle ˜74 days). Final measurements of plant height, water content, root length, and tomato production yield were also performed. Plants mortality right after treatment was higher for plants receiving salicylic acid when compared with SAPAE.

Salicylic acid based-poly(anhydride ester) (SAPAE) homopolymer was synthesized via melt condensation polymerization using methods similar to those disclosed above. Briefly, a salicylic acid based-diacid was first synthesized by an esterification reaction between two molecules of salicylic acid (SA) and adipic acid, using pyridine as the catalyst. After purification and characterization, the diacid was acetylated in excess acetic anhydride for 30 minutes at 80° C. yielding the monomer. Excess acetic anhydride was removed by vacuum distillation. Polymerization was performed at 180° C. for 2 hours under stirring (100 rpm) without the presence of solvent. Polymer was characterized by gel permeation chromatography (GPC) and proton nuclear magnetic resonance (¹H NMR) confirming the structure and purity of the polymer.

Micro-tom was germinated from seeds under hydroponic conditions and grown under vertical farming conditions. Soilless clay media was used, and smart fertilizer was applied. Plants were incubated under normal conditions for 16 days. Seedlings were then transplanted using pre-wet clay and incubated under normal conditions in Percival chambers with abundant water supply and regular water exchanges for an additional 34 days. The Percival chambers were used to mimic environmental conditions. The day and night cycles were set for 16 hour (day) at 25° C. followed by 8 hour (night) at 25° C. CO₂ levels were maintained at 410 ppm with 70% relative humidity.

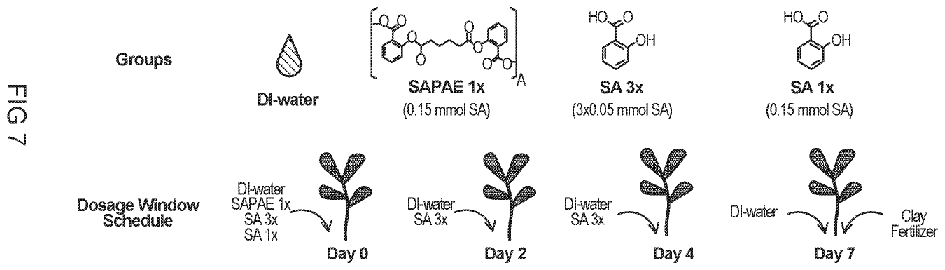

At day 40 of the plant cycle, micro-toms were randomly separated in eight groups of 12 plants: DI-water—Normal, DI-water—Drought, SA 1x—Normal, SA 1x—Drought, SA 3x—Normal, SA 3x—Drought, SAPAE 1x—Normal, SAPAE 1x—Drought. Each plant was labeled, and initial measurements were taken including plant height, total number of leaves, branches, and total number of flower buds, flowers and tomatoes if applicable. Individual group pictures were taken as visual record and first dose was applied accordantly to the group's requirements and schedules (FIG. 7). Dose regimen was similar between all groups with a total duration of 7 days (Dosage Window). Doses were applied at days 0, 2 and 4 of the dosage window. Remaining water in the group trays were removed right before dose applications. Chemicals were applied as a powder directly in the clay surface avoiding contact with the plant. All plants received 75 mL right after dose application. At day 7, remaining water in the trays were removed, final plants measurements and visual observation was recorded. Death plants were removed from the study. Extra clay and fertilizer were added, and DI-water was applied to all plants: 150 mL to normal plants and 50 mL to drought plants to activate the fertilizer.

The treatment window corresponds to the period of time where the groups were exposed to either normal conditions with abundant water supply or to intense drought stress conditions where the water supply was completely removed until plants were found dead. At day 48 of the plant cycle, groups correspondent to the drought condition had all the water removed from the tray and were kept in the chamber. Plants under normal conditions had regularly water exchange two times a week until the end of the plant cycle. All plants were closely monitored, and visible observations were recorded, including measurements of plant height, number of leaves, branches, flower buds, flowers, and tomatoed were taken regularly. Clay and fertilizer were applied as needed and dead plants were removed from the study.

The harvest day was determined by the abundant number of red tomatoes: plant measurements were performed as described above. Plants were removed from their pots and clay was washed out of the roots. Tomatoes were harvested, photographed, and measured (diameter, height and mass). Individual plants were also photographed. Root and plant length was recorded, and plant mass was measured using a scale.

SAPAE polymer was successfully synthesized, and characterization was performed to confirm polymer structure and purity as previously described herein.

TABLE 1
SAPAE polymer molecular weight characterization.

| Polymer Batch # | Mn (kDa) | Mw (kDa) | PDI |
|---|---|---|---|
| LS1-14 | 5.0 | 12.9 | 2.6 |
| ML230713 | 3.8 | 9.7 | 2.5 |
| VB230718 | 3.2 | 8.6 | 2.6 |
| Average | 4.0 ± 0.9 | 10.4 ± 2.2 | 2.6 ± 0.1 |

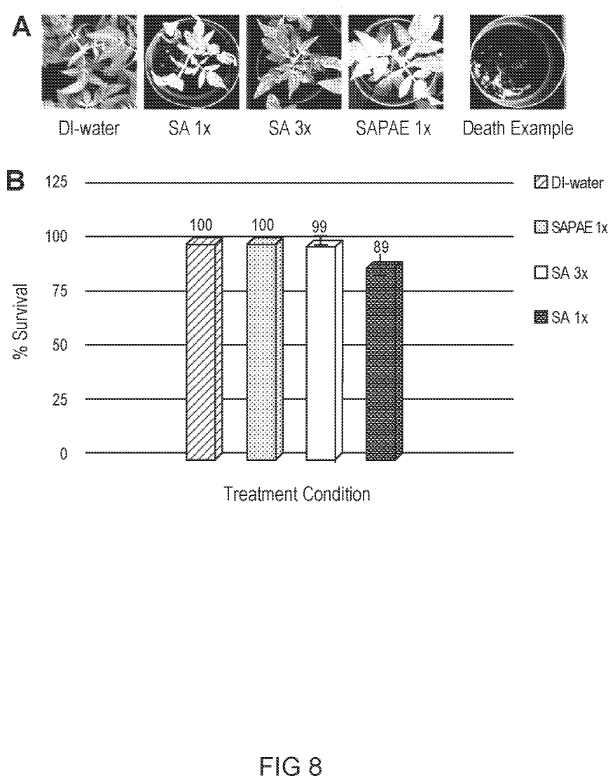

Doses were successfully applied accordantly to the schedules above. Powder application of 0.15 mmol of SA per plant in a single dose (SA 1x) was more harmful to micro-toms when compared with the application of three dosages of 0.05 mmol (SA 3x). Plants receiving a single dose of SAPAE which contains equivalent amounts of SA to the SA 1x (0.15 mmol) did not show any signs of stress or any deaths after the dosage window (FIGS. 8A and 8B). Plants receiving SAPAE behaved as well as the groups receiving DI-water indicating polymer powder is not harmful to the plants at this dose concentration.

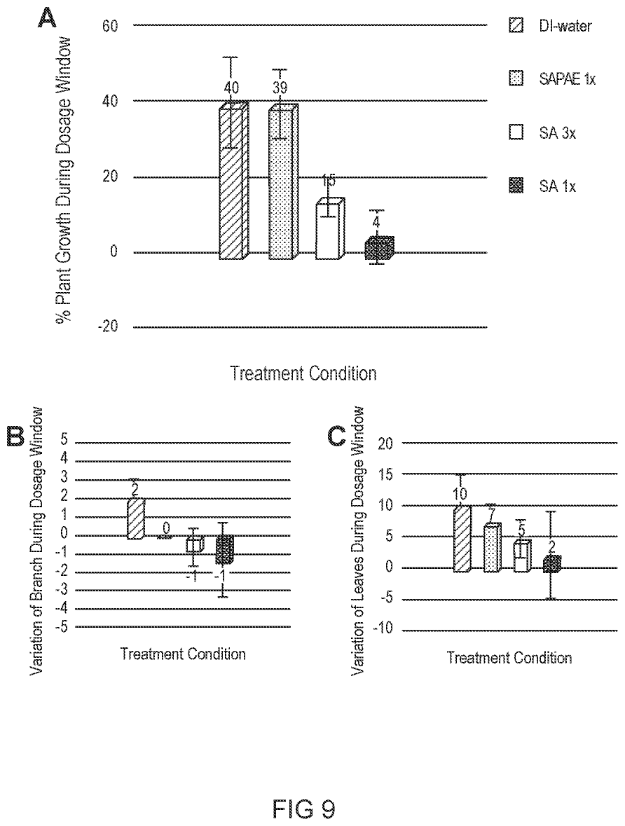

Stress caused by the single application of SA (0.15 mmol) hindered plant growth and plant development as indicated by negligible percent plant growth and by the decrease in the number of branches (FIGS. 9A and 9B). The stress caused by the three dosages of SA (0.05 mmol per dose) was less significative than the stress caused by SA 1x and did not completely hinder plant growth. However, % plant growth was smaller than the DI-water control group. Plants receiving a single dose of SAPAE (1x) had similar growth as the DI-water control groups. Variation in the number of branches and leaves per plant was similar for SA 3x and SAPAE 1x (FIGS. 9B and 9C).

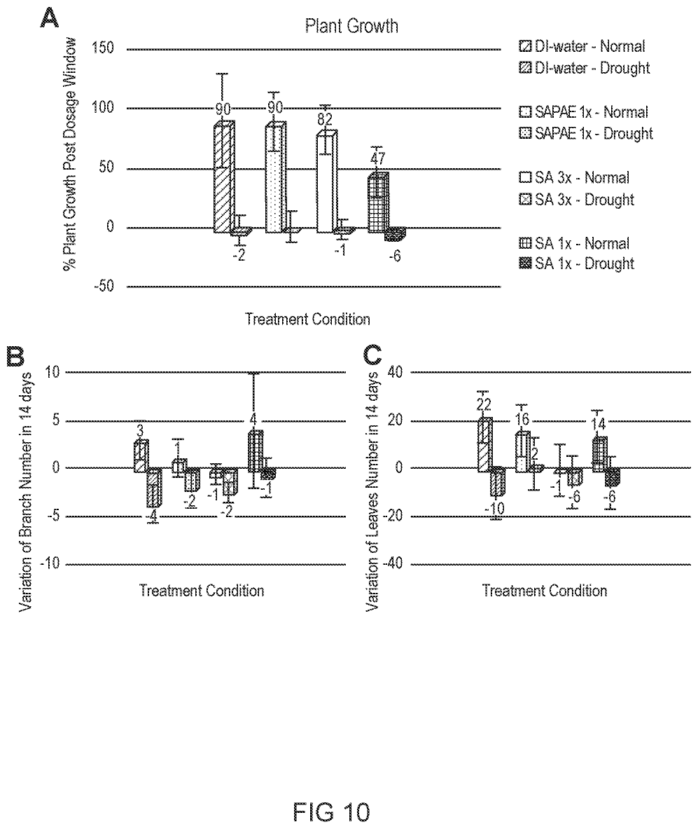

Assuming that the drought group would likely not survive until the end of the plant cycle, measurements were performed post 14 days from the start of the treatment window (FIGS. 10A-10C).

All plants under drought did not grow likely due to the abiotic stress (FIG. 10A). In fact, they lost branches and leaves (FIGS. 10B and 10C). Group that did not receive any chemical (DI-water) seems to have lost more leaves and branches compared with the other groups receiving SA. The difference at that point might not be significant. On the other hand, positive plant growth was observed for plants under normal conditions during the same period of time. Percent plant growth for SAPAE 1x, SA 3x was similar to the DI-water group which confirms visual observation of recovery from the dosage window for SA 3x. Group receiving SA 1x presents the lowest percent growth most likely due to the intense stress suffered during the dosage window. Number of leaves and branches increases for the normal groups except for the SA 3x. It is hypothesized that this group was focusing on recovery and height growth delaying the new leaves and branches formation.

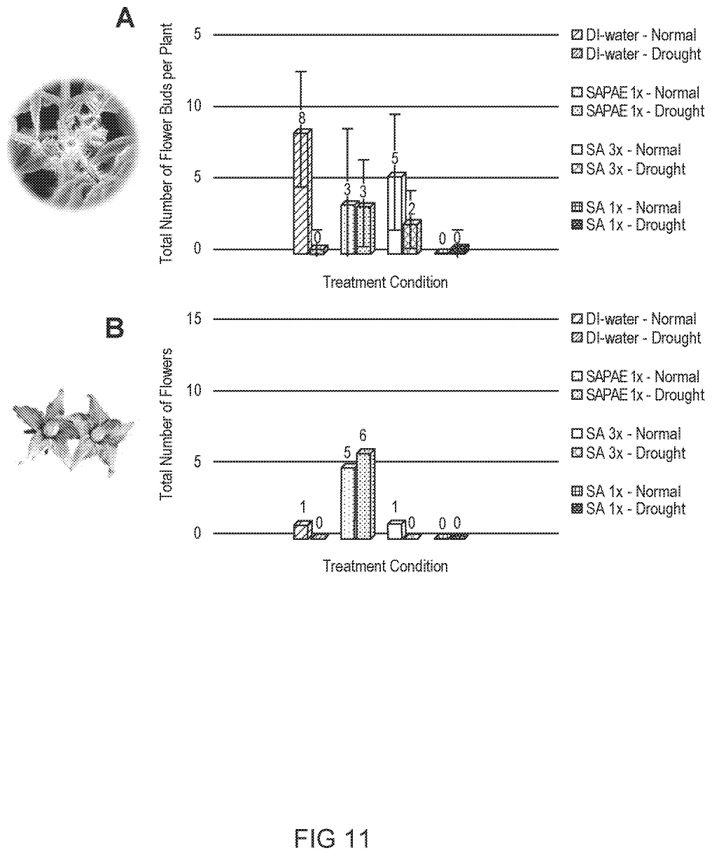

Comparison of the number of flower buds per plant were also measured (FIGS. 11A and 11B). SAPAE 1x was the leading group in producing flowers which is indicated by the higher number of opened flowers at the 14 days treatment time point (FIG. 11B). Following, DI-water seems to be the second leading group with the highest number of unopened flowers at the same time point. Plants receiving SAPAE 1x were able to produce flowers and flower buds despite of drought stress FIGS. 11A and 11B). Plants receiving SA 3x were the second-best group regarding flower production under stress since it also presented flower buds at this stage. No opened flowers were observed. No tomatoes were observed at this point.

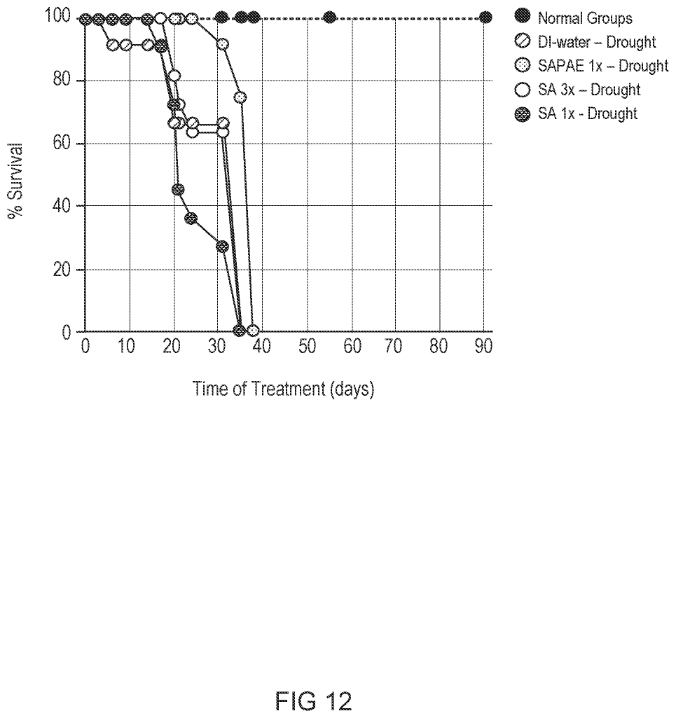

To evaluate the survival of plants over the course of treatment, plants were all evaluated for survival over the course of treatment (FIG. 12). All normal groups present a 100% survival up till tomatoes were harvest (90 days of treatment window). Drought groups were all completely dead by day 38 of treatment window. For the drought groups, DI-water presented the first death after 6 days under drought. SA 1x presented the first death after 17 days. SA 3x was the second-best group taking 20 days to start presenting with dead plants. SAPAE 1x did not present dead plants until day 35 being the most resistant group against drought stress.

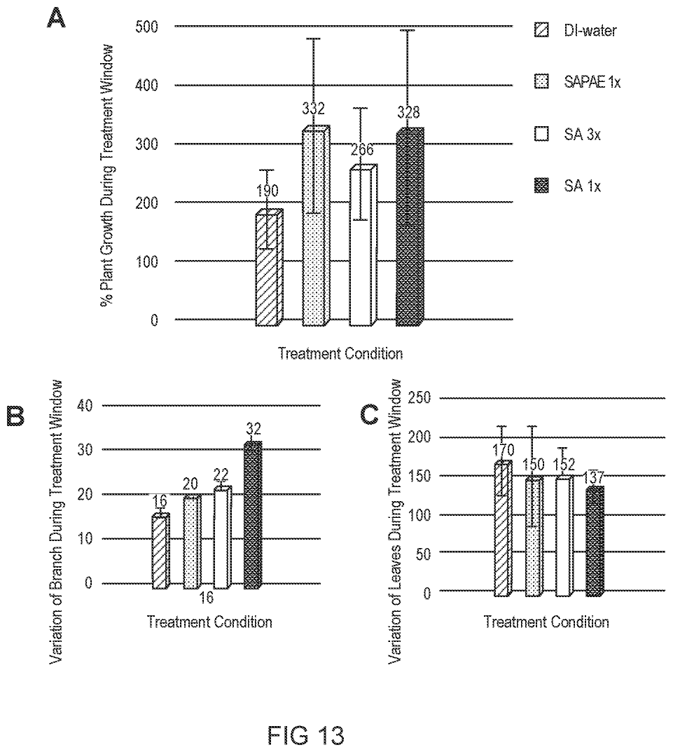

To evaluate the plant growth, a measurement was taken of the total plant height during the treatment study (FIG. 13A), a measurements in the variation in total number of branches per plant (FIG. 13B), and a measurement of the variation in the total number of leaves per plant (FIG. 13C). Percent plant growth of plants receiving chemical treatment was slightly higher than the negative control (DI-water group). Indicating that SA supports plant growth. All groups presented a positive variation of branches and leaves during the treatment window which correspond to the expected plant growth. The highest variation of number of branches observed for SA 1x indicates positive recovery of this group under normal conditions during the treatment window.

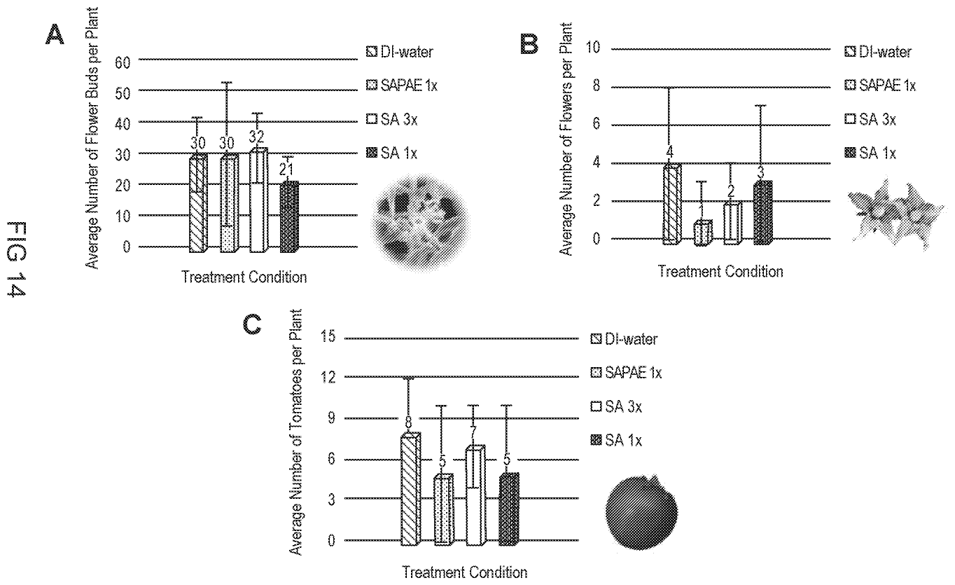

Turning to the evaluation of the number of flowers and number of flower buds it was observed that the number of flower buds significantly increased when compared with the 14-day timepoint for all the groups (FIGS. 14A-14C). Average number of open flowers is small at this stage likely because the plants have already produced tomatoes. No significant difference was observed among the normal groups shown in terms of average number of flower buds, flowers, or tomatoes.

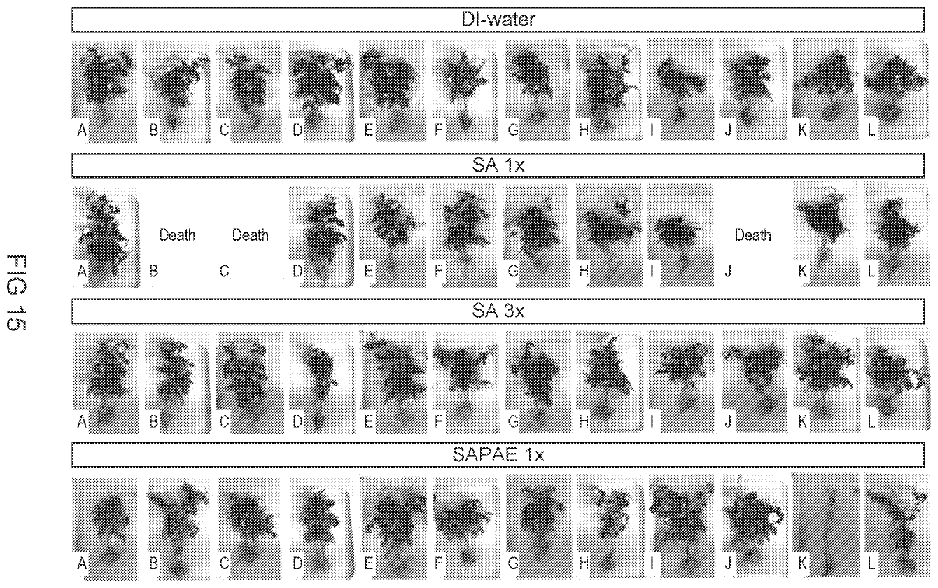

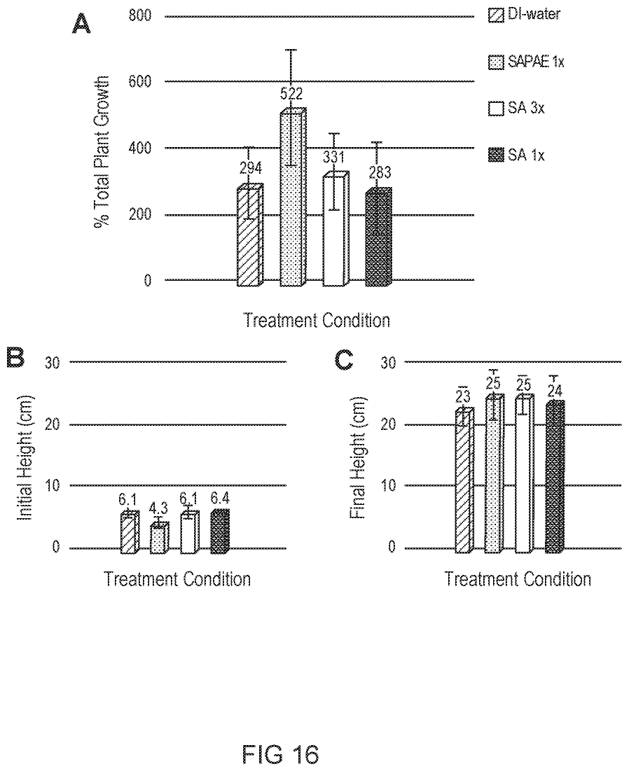

Upon completion of the growth cycles, the plants were harvested and images of individual plants subsequent to removal from the study on harvest day were taken (FIG. 15). It was observed that plants treated with SA 1x resulted in the most plant death across the study with three plants dead at time of harvest. To study the root growth of these plants, the roots were measured, and it was observed that groups SA 3x and SAPAE 1x were stronger at holding the clay in place after being removed from the pot. After the plants were harvested, the total plant growth, the initial height and the final height were measured (FIGS. 16A-16C). The highest percent plant growth observed was for the group receiving the SAPAE 1x and may likely be due to the slightly small initial plant height of this group. Final height was roughly the same for all groups indicating that at this point the micro-toms have reached their maximum height and dosages of SA of any form (SAPAE 1x, SA 3x or SA 1x) did not affect the overall plant growth considering the entire plant cycle.

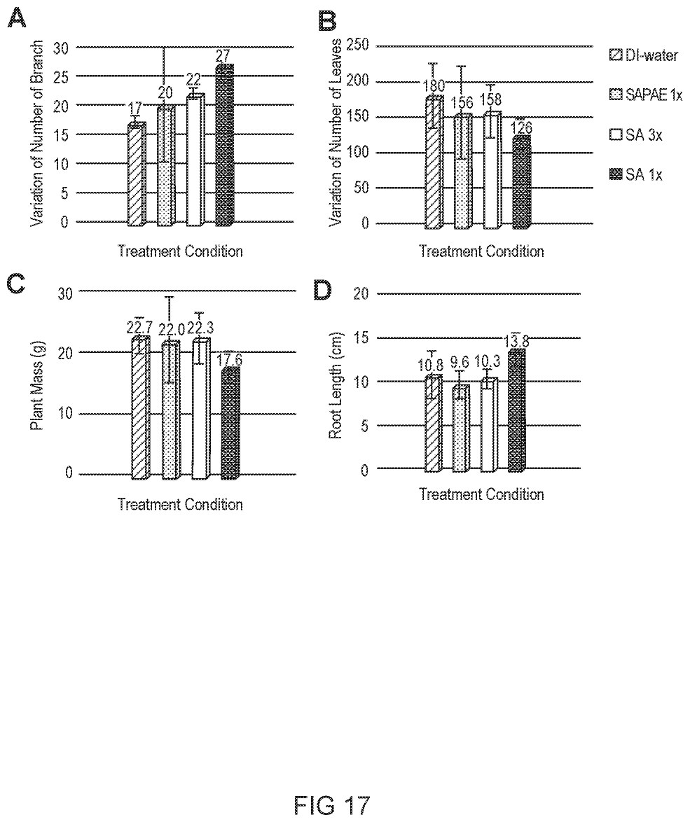

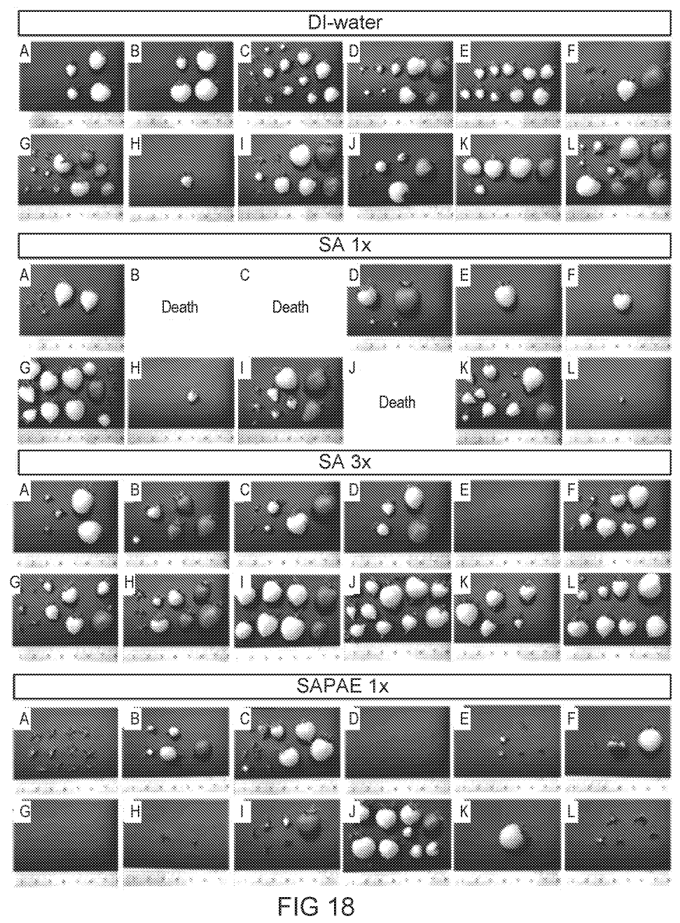

A final measurement of the total number of branches (FIG. 17A), the total number of leaves (FIG. 17B), the plant mass (FIG. 17C), and the root length (FIG. 17D) were performed. It was observed that the total number of branches and leaves were similar among all of the groups. Plant mass and root length were observed to also be similar among all test groups. A visual observation of the harvested tomatoes was also performed, and images were taken on all harvested fruit (FIG. 18).

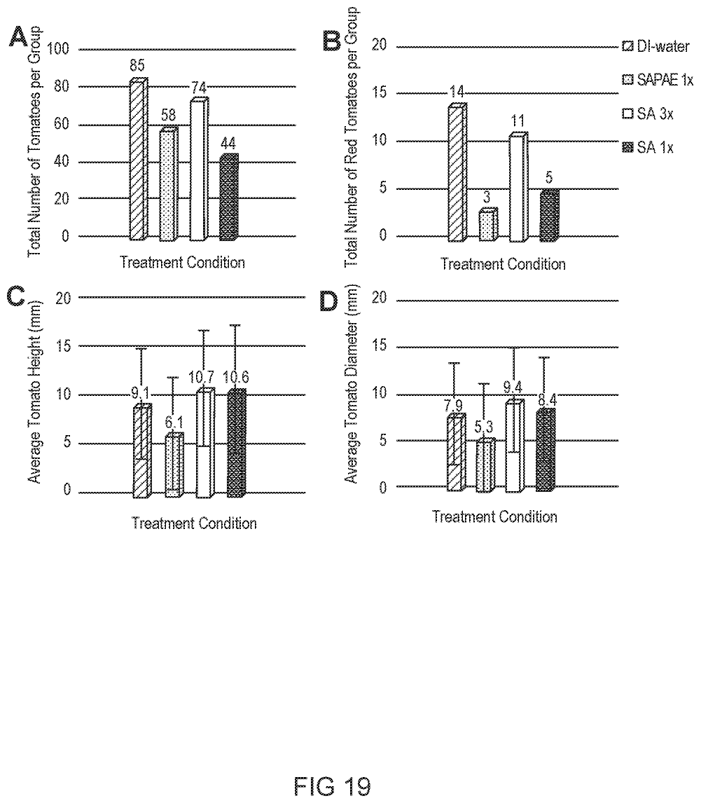

The total number of tomatoes produced was measured and compared across all test groups. Based upon the singular study performed, the total number of tomatoes produced was similar across the DI water and SA 3x sample pools (FIG. 19A). The SAPAE test group produced a smaller number of tomatoes though not significantly less at 58 compared to DI water that produced 85 (FIG. 19A). The total number of red tomatoes across all groups was observed to be varied with the DI water producing the most red tomatoes at 14 (FIG. 19B). The SA 1x and the SAPAE 1x groups were observed to have the least number of red tomatoes (FIG. 19B). The average tomato height was measured across the plants, it was observed that the average tomato height was not significantly different across all test groups (FIG. 19C) as well as the average tomato diameter (FIG. 19D). It is hypothesized that the lower number of red tomatoes in combination with the smaller height and diameter indicates that SAPAE 1x likely took longer to produce tomatoes and did not have enough time to mature the tomatoes, resulting in smaller and more non-red tomatoes.

It was determined that SAPAE was a safe alternative to deliver 0.15 mmol of salicylic acid in a single dose via powder application. The results indicate that the slow release of salicylic acid from the polymer made the plants more resistant to drought stress. Plants receiving SAPAE and SA 3x sustained the plants for longer periods of stress. All plants under drought conditions died after 38 days of stress. All plants under normal conditions were able to recover from the stress caused by the powder application of SA and produce tomatoes. For n=1, plants receiving the polymer took longer to produce tomatoes even though were the first ones to produce flowers. At earlier stages of the treatment window results indicated SA was promoting plant growth independently of the method of application.

What is claimed is:

1. A homopolymer having a backbone, wherein the backbone comprises one or more units of Formula (I): 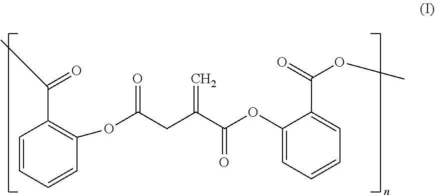
wherein:
n is 1 to 1500.

2. The homopolymer of claim 1, wherein the homopolymer has an average molecular weight of about 1,000 daltons to about 700,000 daltons.

3. The homopolymer of claim 2, wherein the homopolymer has an average molecular weight of about 100,000 daltons to about 600,000 daltons.

4. The homopolymer of claim 3, wherein the homopolymer has an average molecular weight of about 200,000 daltons to about 500,000 daltons.

5. The homopolymer of claim 1, wherein hydrolysis of the homopolymer yields the following products:

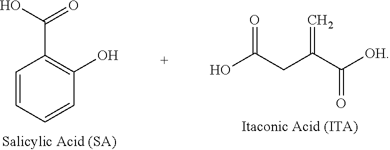

6. The homopolymer of claim 1, wherein the homopolymer further comprises an active agent.

7. The homopolymer of claim 6, wherein the active agent is selected from the group consisting of a fertilizer, urea, and monopotassium-phosphate.

8. The homopolymer of claim 6, wherein the active agent is a fertilizer.

9. A copolymer having a backbone, wherein the backbone comprises:
(a) one or more units of Formula (I): 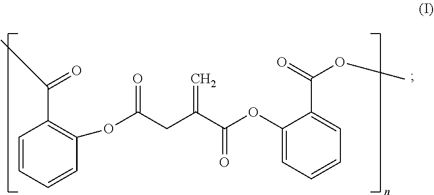
(b) one or more units of Formula (II): 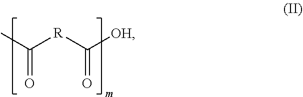
wherein:
n is 1 to 1500;
m is 1 to 1500; and
each R is independently a linker.

10. The copolymer of claim 9, wherein R is a divalent, branched or unbranched, saturated or unsaturated, hydrocarbon chain, having from 1 to 25 carbon atoms, and wherein one or more of the carbon atoms is optionally replaced by (—O—), (—NR¹—) or phenylene, and wherein the chain is optionally substituted on carbon with one or more substituents selected from the group consisting of (C₁-C₆)alkoxy, (C₁-C₆)cycloalkyl, (C₁-C₆)alkanoyl, (C₁-C₆)alkanoyloxy, (C₁-C₆)alkoxycarbonyl, (C₁-C₆)alkylthio, azido, cyano, nitro, halo, hydroxy, oxo, carboxy, aryl, aryloxy, heteroaryl, and heteroaryloxy, wherein each R¹ is independently selected from H or (C₁-C₆)alkyl.

11. The copolymer of claim 9, wherein each R is independently selected from the group consisting of

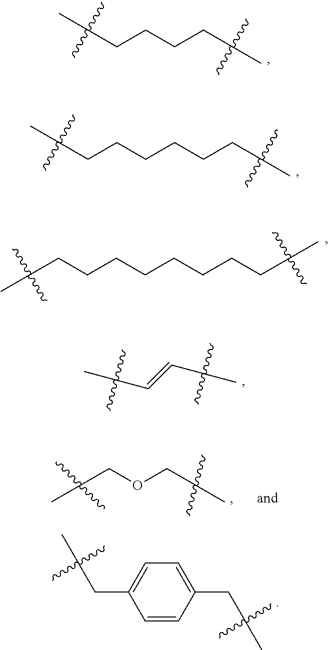

12. The copolymer of claim 9, wherein the copolymer has an average molecular weight of about 1,000 daltons to about 700,000 daltons.

13. The copolymer of claim 12, wherein the copolymer has an average molecular weight of about 100,000 daltons to about 600,000 daltons.

14. The copolymer of claim 13, wherein the copolymer has an average molecular weight of about 200,000 daltons to about 500,000 daltons.

15. The copolymer of claim 9, wherein the ratio of the (a) one or more units of Formula (II) to the (b) one or more units of Formula (III) ranges from between 10:1 to 1:10.

16. The copolymer of claim 9, wherein the ratio of the (a) one or more units of Formula (II) to the (b) one or more units of Formula (III) ranges from between 5:1 to 1:5.

17. The copolymer of claim 9, wherein the ratio of the (a) one or more units of Formula (II) to the (b) one or more units of Formula (III) ranges from between 2:1 to 1:2.

18. The copolymer of claim 9, wherein the ratio of the (a) one or more units of Formula (II) to the (b) one or more units of Formula (III) ranges from between 1:1 or 2:1.

19. The copolymer of claim 9, wherein upon hydrolysis the copolymer yields the following products:

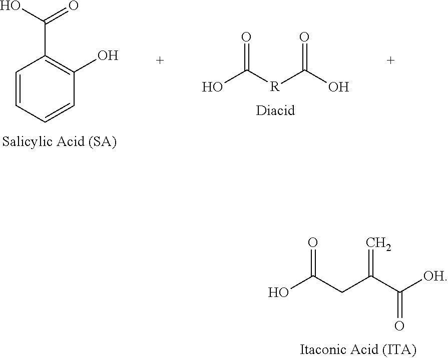

20. The copolymer of claim 9, wherein the copolymer further comprises an active agent.

21. The copolymer of claim 20, wherein the active agent is selected from the group consisting of a fertilizer, urea, and monopotassium-phosphate.

22. The copolymer of claim 21, wherein the active agent is a fertilizer.

23. A copolymer having a backbone, wherein the backbone comprises:
(a) one or more units of Formula (III): 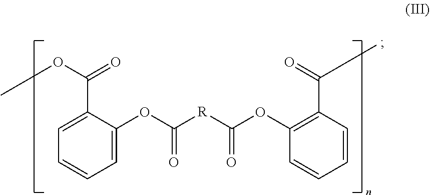
(b) one or more units of Formula (IV): 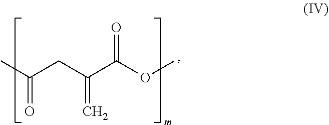
wherein:
n is 1 to 1500:
m is 1 to 1500; and
each R is independently a linker.

24. The copolymer of claim 23, wherein R is a divalent, branched or unbranched, saturated or unsaturated, hydrocarbon chain, having from 1 to 25 carbon atoms, and wherein one or more of the carbon atoms is optionally replaced by (—O—), (—NR¹—) or phenylene, and wherein the chain is optionally substituted on carbon with one or more substituents selected from the group consisting of (C₁-C₆)alkoxy, (C₃-C₆)cycloalkyl, (C₁-C₆)alkanoyl, (C₁-C₆)alkanoyloxy, (C₁-C₆)alkoxycarbonyl, (C₁-C₆)alkylthio, azido, cyano, nitro, halo, hydroxy, oxo, carboxy, aryl, aryloxy, heteroaryl, and heteroaryloxy, wherein each R¹ is independently selected from H or (C₁-C₆)alkyl.

25. The copolymer of claim 24, wherein each R is independently selected from the group consisting of

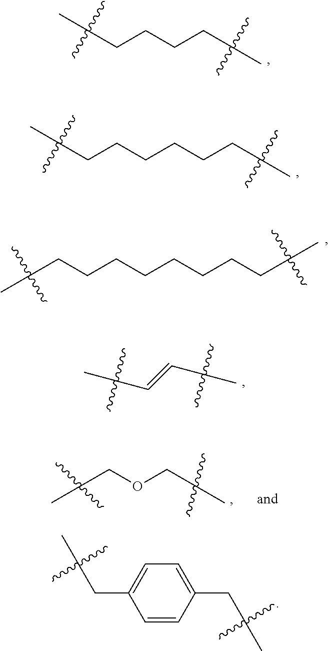

26. The copolymer of claim 23, wherein the copolymer has an average molecular weight of about 1,000 daltons to about 700,000 daltons.

27. The copolymer of claim 12, wherein the copolymer has an average molecular weight of about 100,000 daltons to about 600,000 daltons.

28. The copolymer of claim 13, wherein the copolymer has an average molecular weight of about 200,000 daltons to about 500.000 daltons.

29. The copolymer of claim 23, wherein the ratio of the (a) one or more units of Formula (II) to the (b) one or more units of Formula (III) ranges from between 10:1 to 1:10.

30. The copolymer of claim 23, wherein the ratio of the (a) one or more units of Formula (II) to the (b) one or more units of Formula (III) ranges from between 5:1 to 1:5.

31. The copolymer of claim 23, wherein the ratio of the (a) one or more units of Formula (II) to the (b) one or more units of Formula (III) ranges from between 2:1 to 1:2.

32. The copolymer of claim 23, wherein the ratio of the (a) one or more units of Formula (II) to the (b) one or more units of Formula (III) ranges from between 1:1 or 2:1.

33. The copolymer of claim 23, wherein upon hydrolysis the copolymer yields the following products:

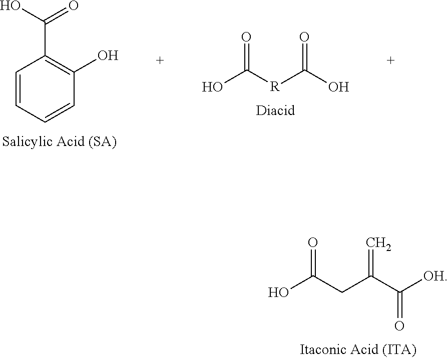

34. The copolymer of claim 23, wherein the copolymer further comprises an active agent.

35. The copolymer of claim 34, wherein the active agent is selected from the group consisting of a fertilizer, urea, and monopotassium-phosphate.

36. The copolymer of claim 35, wherein the active agent is a fertilizer.

37. A hydrogel comprising a plurality of homopolymers having a backbone, wherein the backbone comprises one or more units of Formula (I): 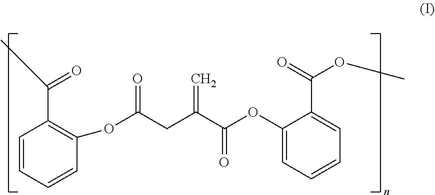
wherein n is 2 to 1500; and
wherein the homopolymers are cross-linked.

38. A hydrogel comprising a plurality of copolymers having a backbone, wherein the backbone comprises:
(a) one or more units of Formula (I): 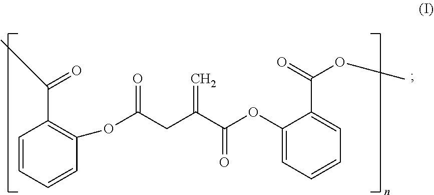
(b) one or more units of Formula (II): 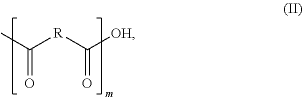
wherein:
n is 1 to 1500;
m is 1 to 1500; and
each R is independently a linker; and
wherein the copolymers are cross-linked.

39. A hydrogel comprising a plurality of copolymers having a backbone, wherein the backbone comprises:
(a) one or more units of Formula (III): 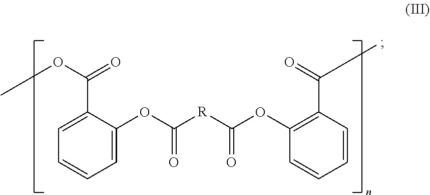
(b) one or more units of Formula (IV): 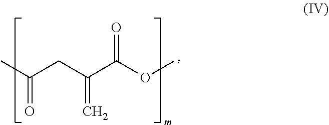
wherein:
n is 1 to 1500;
m is 1 to 1500; and
each R is independently a linker; and
wherein the copolymers are cross-linked.

40. A hydrogel comprising a homopolymer of any one of claims 1-8 and a second copolymer, wherein the second copolymer is selected from the group consisting of a synthetic polymer, a natural polymer, and combinations thereof, wherein the homopolymer and the second copolymer are cross-linked.

41. A hydrogel comprising a copolymer of any one of claims 9-22 and a second copolymer, wherein the second copolymer is selected from the group consisting of a synthetic polymer, a natural polymer, and combinations thereof, wherein the copolymer and the second copolymer are cross-linked.

42. A hydrogel comprising a copolymer of claims 23-36 and a second copolymer, wherein the second copolymer is selected from the group consisting of a synthetic polymer, a natural polymer, and combinations thereof, wherein the copolymer and the second polymer are cross-linked.

43. The hydrogel of any one of claims 40-42, wherein the second copolymer is a natural polymer.

44. The hydrogel of claim 43, wherein the natural polymer is selected from the group consisting of carboxymethyl cellulose, starch, cellulose derivative, or chitosan.

45. The hydrogel of any one of claims 40-42, wherein the second copolymer is a synthetic polymer.

46. The hydrogel of claim 45, wherein the synthetic polymer is a hydrophilic polymer.

47. The hydrogel of claim 46, wherein the hydrophilic polymer is selected from the group consisting of poly(N-vinyl-2-pyrrolidone), polyvinylpolypyrrolidone, poly(vinyl alcohol), polyurethane, or poly(ethylene oxide), and combinations thereof.

48. The hydrogel of any one of claims 40-47, wherein the copolymer further comprises an active agent.

49. The hydrogel of claim 48, wherein the active agent is selected from the group consisting of a fertilizer, urea, and monopotassium-phosphate.

50. The hydrogel of claim 49, wherein the active agent is a fertilizer.

51. The hydrogel of claim 40, wherein the ratio of the homopolymer to the second copolymer is 10:1 to 1:10.

52. The hydrogel of claim 41, wherein the ratio of the copolymer to the second copolymer is 10:1 to 1:10.

53. The hydrogel of claim 42, wherein the ratio of the copolymer to the second copolymer is 10:1 to 1:10.

54. A hydrogel comprising a first copolymer of any one of claims 9-22 and a second copolymer of any one of claims 23-36, wherein the first copolymer and the second copolymer are cross-linked.

55. A method of treating a plant, seed, or crop comprising, the method comprising administering a homopolymer comprising one or more units of Formula (III) to a plant, crop, or seed: 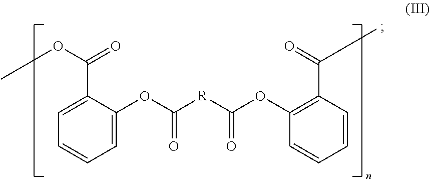
wherein: n is 1 to 1500; m is 1 to 1500; and each R is independently a linker.

56. The method of claim 55, wherein R is a divalent, branched or unbranched, saturated or unsaturated, hydrocarbon chain, having from 1 to 25 carbon atoms, and wherein one or more of the carbon atoms is optionally replaced by (—O—), (—NR¹—) or phenylene, and wherein the chain is optionally substituted on one or more carbon with one or more substituents selected from the group consisting of (C₁-C₆)alkoxy, (C₃-C₆)cycloalkyl, (C₁-C₆)alkanoyl, (C₁-C₆)alkanoyloxy, (C₁-C₆)alkoxycarbonyl, (C₁-C₆)alkylthio, azido, cyano, nitro, halo, hydroxy, oxo, carboxy, aryl, aryloxy, heteroaryl, and heteroaryloxy, wherein each R¹ is independently selected from H or (C₁-C₆)alkyl.

57. The method of claim 55, wherein R is selected from the group consisting of:

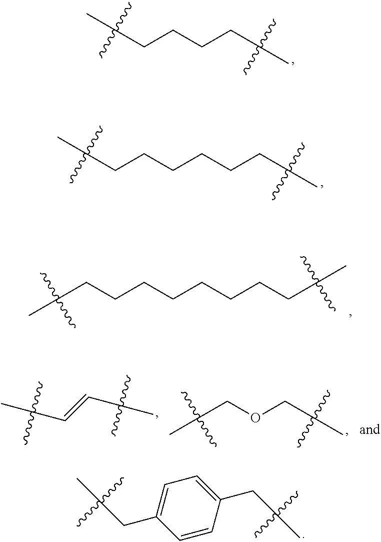

58. The method of claim 56, wherein the homopolymer is administered as a powder to the plant, seed, or crop.

59. A method of delivering salicylic acid to a seed, a plant, or a crop, the method comprising applying to the seed, the plant, or the crop a hydrogel of any one of claims 37-54.

60. A method of delivering salicylic acid to a seed, a plant, or a crop, the method comprising applying to the seed, the plant, or the crop a powdered form of the homopolymer of any one of claims 1-8 or the copolymer of any one of claims 9-36.

61. A method for combating drought stress, the method comprising applying to a seed, a plant, or a crop a powdered form of the homopolymer of any one of claims 1-8 or the copolymer of any one of claims 9-36.

62. A method of increasing the growth of a seedling and/or increasing the drought tolerance of a seedling, the method comprising (a) exogenously adding to a seed of the seedling with a homopolymer of any one of claims 1-8 or the copolymer of any one of claims 9-36, (b) planting the seed in growth conditions, and (c) allowing the seed to grow into a seedling, thereby increasing the growth of the seedling and/or increasing the drought tolerance of the seedling.

63. A method for promoting plant growth and production, the method comprising applying to a plant a powdered form of the homopolymer of any one of claims 1-8 or the copolymer of any one of claims 9-36.

64. A method for combating drought stress, the method comprising applying to a seed, a plant, or a crop a hydrogel of any one of claims 37-54.

65. A method of increasing the growth of a seedling and/or increasing the drought tolerance of a seedling, the method comprising (a) coating a seed of the seedling with a hydrogel of any one of claims 37-54, (b) planting the coated seed in growth conditions, and (c) allowing the seed to grow into a seedling, thereby increasing the growth of the seedling and/or increasing the drought tolerance of the seedling.

66. A method for promoting plant growth and production, the method comprising applying to a plant a hydrogel of any one of claims 37-54.
